SEQUENCE LISTING (4 sequences)

SEQ ID NO: 1 - DNA, 20 bp, Artificial
  The bonding element which was immobilized on basal plate
cgacggatccccgggaattc

SEQ ID NO: 2 - DNA, 20 bp, Artificial
  The antibonding element which is complementary sequence as agains t sequence No.1
gaattcccggggatccgtcg

SEQ ID NO: 3 - DNA, 20 bp, Artificial
  The bonding element which was immobilized on basal plate
atagtgttctgggttagcaa

SEQ ID NO: 4 - DNA, 20 bp, Artificial
  The antibonding element which is complementary sequences as again st sequence No.3
ttgctaacccagaacactat

(19) United States
(12) Patent Application Publication
(10) Pub. No.: US 2008/0254997 A1
(43) Pub. Date: Oct. 16, 2008

(54) Kit, Device and Method For Analyzing Biological Substance

(75) Inventors: Yuichi Oku, Ibaraki (JP); Shuichi Akaba, Ibaraki (JP)

Correspondence Address: BACON & THOMAS, PLLC, 625 SLATERS LANE, FOURTH FLOOR, ALEXANDRIA, VA, 22314-1176, US

(73) Assignee: NISSUI PHARMACEUTICAL CO., LTD., TOKYO, JAPAN (JP)

(21) Appl. No.: 10/593,145

(22) PCT Filed: Mar. 18, 2005
(86) PCT No.: PCT/JP05/04953

§ 371 Date: Sep. 18, 2006

(30) Foreign Application Priority Data
Mar. 18, 2004 (JP) 2004-078394

(51) Int. Cl. C40B 30/04; C40B 60/12; C40B 50/18

(52) U.S. Cl. 506/9; 506/39; 506/32

(57) ABSTRACT

The invention provides an analytical device insusceptible to inactivation or other influences even when exposed to a thermal load or organic compounds contained in an adhesive in the process for manufacturing the same and, more over, allowing an immunological substance or the like to be readily immobilized at a site in the microchannel passage therein.

The analytical kit is a combination of the analytical device and a reagent or reagents. The analytical device used in the analytical kit comprises a passage 2, 1 μm-5mm width and 1 μm-750 μm depth in cross-section formed therein and belongs to the category of the so-called microfluidic systems suited for analyzing very small amounts of liquid samples; thus, it is suited for analyzing biological substances. The analytical device 1 to be used in the analytical kit is prepared by forming a groove not wider than 5 mm on a first member 5 and/or second member 6, immobilizing a nucleic acid(s) at a part (capturing zone 7) of a place to become the channel 2 after joining the two members together and joining the two members together. The reagent(s) is (are) used after joining of the two members of the analytical device 1 and therefore will not be influenced by the fusion or adhesive.

### TECHNICAL FIELD

The present invention relates to a device for analyzing a biological substance which device has a passage or channel with a very small cross-sectional area and is called “microchip”, to an analytical kit comprising such analytical device and necessary reagents, and to an analytical method using that analytical device.

### BACKGROUND ART

Methods for most generally analyzing biopolymers are encountered in clinical laboratory testing. In clinical laboratory testing, a blood sample is collected, generally in an amount of 5-10 mL, in a blood collecting tube and analyzed for antigens and antibodies, among others, contained in the plasma and/or serum fraction. Since the diagnosis of a disease is made based on the clinical symptom or the combination with the results of a plurality of test items, the doctor in charge takes a combination of test items into consideration according to the possible disease. In such testing, the blood sample collected from a patient is carried to a laboratory and tested on a large-sized testing apparatus disposed there for a plurality of different items. Then, the measurement results are sent to the doctor in charge, who informs the patient visiting the hospital several days later of the result of diagnosis of the disease as obtained based on the test results. Such analytical apparatus is generally a large-sized one installed in a clinical laboratory and, in operating such apparatus, a warm-up is always necessary and, therefore, such apparatus is not very suited for testing in case of emergency. The blood amount to be collected for testing on such an analytical apparatus is large for an infant or elderly person and this is a heavy burden on such person. Another problem is that the testing causes a time lag, which makes it difficult to give immediate appropriate treatment.

To overcome these difficulties, reagents for various test methods have been developed. For example, mention may be made of the method described in Japanese Patent Laid-Open Publication (JP-T) No. 1503174 (Patent Document 1) and the immunochromatographic method disclosed in U.S. Pat. No. 6,448,001 (Patent Document 2). According to the methods utilizing these technologies, the set of necessary reagents can be stored at room temperature in a space of a size about half that of a name card and it is possible to judge the presence or absence of a target or targets of analysis at the bedside in a very simple and easy way. However, these methods are not always high in sensitivity since the judgment is made by visual observation. Further, they cannot be quantitative and, since it is necessary to collect about 100 μL of blood for each analytical procedure, they cannot reduce the load on the patient side as yet.

An analytical apparatus utilizing evanescent waves as described in JP-A No. S63-273042 (Patent Document 3) has also been developed to overcome the above difficulties. By using this apparatus, it becomes possible to carry out quantitative analyses but it is necessary to collect 20-50 μL of blood for each analytical procedure. Thus, the difficulties have not yet been solved although that technology shows improvements as compared with the prior art technologies.

In recent years, a microfluidic system technology-based analytical method called MicroTAS (Micro Total Analysis System) has been devised and has come into use for analyzing, identifying or purifying biopolymers. In the background thereof, there are increasing demands in the fields of biotechnology, typically genome analysis and proteomics, for obtaining full information from a sample of a very small size in a short period of time.

Since miniaturization or microminiaturization of passages or channels in a microfluidic system results in increases in reaction surface area per unit volume, as is already known, the reaction time can be markedly shortened and the size of information obtainable per unit time can be increased. Furthermore, the volume is very small, so that a number of effects can be obtained: for example, it becomes easy to maintain the uniformity in fluid temperature and the amounts of reagents and waste fluid can be markedly reduced.

In this way, the microfluidic system is expected to exert great influences on a very large number of industries, including biotechnology-related industries such as chemical and pharmaceutical industries, in particular, and, further, food and agricultural industries.

An immunoassay procedure utilizing such a microfluidic system has been established by Sato et al. (Analytical Chemistry 2001, 73, 1213-1218 (Non-Patent Document 1), JP-A No. 2001-4628 (Patent Document 4)). According to their method, a dam-like structure is disposed midway in a channel with a width of 200 μm, a depth of 100 μm and a length of 50.4 mm on a microchip made of glass, and a mouse anti-carcinoembryonic antigen antibody is bound beforehand to a polystyrene bead having a particle diameter enabling the same to be intercepted by that dam. The mouse anti-carcinoembryonic antigen antibody-bound bead is allowed to flow into the channel from a channel inlet and be intercepted by the dam in front of the same to thereby form an antibody-bound bead region. The carcinoembryonic antigen at one of various concentrations is poured into the channel to form a mouse antibody-bound bead-antigen complex. After washing, a rabbit anti-carcinoembryonic antigen anti body is reacted with the complex to form a mouse antibody-bound bead-antigen-rabbit anti-carcinoembryonic antigen antibody complex. After further washing, a colloidal gold-labeled anti-rabbit IgG antibody is reacted with the complex to form a mouse anti-carcinoembryonic antigen antibody-bound bead-antigen-rabbit anti-carcinoembryonic antigen antibody-colloidal gold-labeled anti-rabbit IgG antibody complex. Then, after washing, the concentration of the antigen, namely carcinoembryonic antigen, is determined based on the amount of colloidal gold bound using a thermal lens microscope (Analytical Chemistry 2001, 73, 2112-2116 (Non-Patent Document 2)). By using the microfluidic system, they succeeded in shortening the required time to 30 minutes as compared with the conventional enzyme-linked immunosorbent assay (ELISA) procedure requiring 45 hours. As for the assay sensitivity, they accomplished a detection limit of 0.03 ng/mL by utilizing the microfluidic system as compared with 1 ng/mL in ELISA. Furthermore, the sample volume to be used is as small as 5 μL.

However, the process for preparing microchips for use in analysis according to Sato et al. is very complicated and therefore the cost reduction cannot be strived for; this is the greatest disadvantage. For example, a concrete process for manufacturing the microchips includes the following steps: first, a glass sheet made of Pyrex (registered trademark; product of Corning), for instance, is washed. The washing is generally carried out using several liquid chemicals. After drying, this glass sheet is coated with a photoresist. Then, a mask and the glass sheet are set on an apparatus for exposure to light, followed by exposure to light. Then, the sheet is immersed in a developing solution for development and, after the lapse of a certain predetermined time, washed in a rinsing solution. After washing, etching is performed with hydrogen fluoride; at this time point, a channel is produced. Thereafter, the photoresist is removed and the side etched with the channel is completed. For allowing a liquid to flow through the channel, a counterpart glass sheet provided with a channel inlet and a channel outlet by making holes using a drill or the like is closely attached to the channel-etched glass sheet, and the sheets are fused together at about 650° C. for about 5 hours. Thus is completed a microchip through which fluids can flow. However, this is not yet sufficient for analyzing the binding of a biopolymer such as an antigen. An antibody-bound polystyrene bead is allowed to flow into the channel from the channel inlet and be intercepted at a site to serve as a reaction zone; only then, the microchip can be used for biopolymer analysis. As explained above, the glass-based chips require a very large number of steps and therefore are not always suited for mass production; the cost reduction cannot be attempted.

As mentioned above, heating at about 650° C. is required for fusing together two substrates for forming a microchannel in the process for manufacturing microchips to be used in analyses according to Sato et al. Therefore, for preventing an antibody or a like protein from being heated, it is necessary to introduce, after microchannel formation by fusing two substrates together, an antibody bound to a glass bead or polymer bead as a solid phase for capturing an immunological substance in a sample by the antigen-antibody reaction into the microchannel and cause the bead to be intercepted within the microchannel; only thereafter, the microchip can be used.

A microchip manufacturing technology which uses a plastic as the raw material has also been reported (Analytical Chemistry: 69(14): 2626-2630 (Non-Patent Document 3)). However, the microchip described in Non-Patent Document 3 is merely a device for separating DNA species by electrophoresis but is not intended for capturing and analyzing a biological substance by specific binding. The microchip manufacturing method described in Non-Patent Document 3 comprises pouring a molten plastic into a mold corresponding to a microchannel in the manner of injecting molding and thus molding a member corresponding to the microchannel and bonding a separately prepared member to the above-mentioned member by some means to give a microchip having a microchannel. This method requires a smaller number of steps and is very advantageous from the mass production and cost viewpoint as compared with glass chips and the like. However, for capturing and analyzing a biological substance by this method through specific binding in the same mode as adopted by Sato et al., it is essential to provide a dam-like shape on the mold side, manufacture a microchip in such a manner as mentioned above and introduce an antibody-bound bead thereinto. Therefore, in spite of the fact that the microchip itself can be manufactured at low cost, it cannot always be expected, in view of the subsequent steps, that an advantage will be found from the cost viewpoint.

A biochannel assay technique for hybridizing with a biological material using a microfluidic device is reported in WO01/034302 (Patent Document 5). The assay technique disclosed in that document comprises immobilizing a specific binding counterpart member, for example a DNA, RNA, polypeptide, nucleic acid or antibody/antigen, on a microstructure formed within a microchannel or on a bead placed within the same and allowing a sample to flow through the microchannel in that state for the formation of a bound pair and detecting the bound pair. However, there is no concrete proposal for producing the analytical device in a manner such that any biological substance will not be inactivated.

WO 02/065138 (Patent Document 6) discloses detection of the binding between a biopolymer and a sample on a microchip and recovery and identification of the compound bound.
Patent Document 1: Japanese Patent Laid-Open (JP-T) No. 1503174
Patent Document 2: U.S. Pat. No. 6,448,001
Patent Document 3: JP-A No. S63-273042
Patent Document 4: JP-A No. 2001-4628
Patent Document 5: WO 01/034302
Patent Document 6: WO 02/065138
Patent Document 7: JP-A No. H11-187900
Patent Document 8: U.S. Pat. No. 5,445,934
Patent Document 9: U.S. Pat. No. 5,807,522
Patent Document 10: JP-A No. 2000-356611
Patent Document 11: Japanese Translation of Unexamined PCT Appln. No. H09-503060 (WO 95/08774)
Non-Patent Document 1: Analytical Chemistry 2001, 73, 1213-1218
Non-Patent Document 2: Analytical Chemistry 2001, 73, 2112-2116
Non-Patent Document 3: Analytical Chemistry 69 (14), 2626-2630
Non-Patent Document 4: FASEB J. Jun. 14, 2000(9):1041-60
Non-Patent Document 5: J. Biomol. Struct. Dyn. Oct. 17, 1999(2):175-191
Non-Patent Document 6: Molecular Cloning, second edition, Sambrook, Fritsch and Maniatis, Cold Spring Harbor Laboratory Press, 1989, 9.14-9.19
Non-Patent Document 7: Applied Biosystems DNA Synthesizer model 391 use manual “User Bulletin No. 50”

### DISCLOSURE OF INVENTION

### Problems to be Solved by the Invention

A method used for immobilizing either one of biological substances capable of specific mutual binding, for example immunological substances including an antigen and an antibody, in a passage called channel in a microchip comprises immobilizing either one of the biological substances to be assayed at a site to become the passage on two members for forming the passage in advance and then bonding the two members by means of thermal fusion or an adhesive. On the occasion of such bonding, a problem arises, namely the specific binding ability of the biological substance is inactivated under the influence of the heat or adhesive required. In constructing a microchip or a like analytical device for precisely analyzing a biological substance suspected to be contained in a very small amount of a sample by immobilizing an accurately determined very small amount of a biological substance, the influence of heat or a volatile organic compound contained in the adhesive on the occasion of bonding cannot be neglected.

Therefore, the advent of an analytical device which will not allow influences such as inactivation even when there is an influence of the thermal load or of the organic compound contained in the adhesive in the process of production of the analytical device, and which makes it easy to immobilize an immunological substance or the like at a site to become the microchannel passage is desired.

The prior art devices having a microchannel therein and intended for analyzing a biological substance are specialized in analysis of a specific biological substance to be assayed and therefore cannot be readily used for analyzing another biological substance. They are thus lacking in general purpose feature and therefore disadvantageous from the production cost viewpoint.

The present invention has been made to solve such problems as mentioned above.

### Means for Solving the Problems

The analytical device of the invention, which is used for the analysis of a biological substance, belongs to the so-called microfluidic system suited for analyzing a very small amount of a liquid sample. The analytical device to be used in the analytical kit of the invention has a passage or channel constructed by forming a groove with a passage width of not wider than 5 mm on either one of two sheet members and bonding the two members together so that the passage has, in its cross section, a width of 1 μm to 5 mm and a depth of 1 μm to 750 μm. Before bonding these two members, a nucleic acid is bound to a part of the portion to become the passage and then, after bonding together, a reagent containing a conjugate between a nucleic acid capable of complementarily binding to the former nucleic acid and a ligand capable of specifically binding to a biological substance to be assayed is introduced into the passage in the analytical device to thereby immobilize the ligand in the analytical device, so that the ligand will never be exposed to the influence of the heat for fusion bonding or the organic solvent from the adhesive on the occasion of bonding together the two members in the process of manufacturing the analytical device and the function of capturing the biological substance is retained.

The analytical method of the invention consists, in its first fundamental aspect, in a method of introducing a mixture of a liquid sample and an analytical reagent into an analytical device and is an analytical method comprising the following elements i) to iv).

i) Preparing an analytical device having a passage allowing a liquid to flow therethrough as formed by bonding together a first member having a groove, 1 μm to 5 mm width and 1 μm to 750 μm depth in its cross-section, and a second member capable of covering the groove, together with a first nucleic acid (N1) having an arbitrary base sequence as immobilized in a capturing zone provided in the passage on the first member and/or second member prior to bonding the first member and second member together;

ii) Preparing a reagent A containing a conjugate (N2-L1) resulting from binding of a first ligand (L1) capable of specifically binding to a biological substance to be assayed to a second nucleic acid (N2) having a base sequence at least complementary to the first nucleic acid (N1);

iii) Introducing a liquid sample suspected of the occurrence therein of the biological substance to be assayed and the reagent A, either after preliminary mixing thereof for conjugate formation or while allowing conjugate formation, into the passage in the analytical device for immobilizing the resulting conjugate within the passage;

iv) Assaying the immobilized conjugate.

The phrase “at least complementary” as used herein means that while the strongest binding can be expected when the combination of complementary nucleic acid chains is a perfectly matching one, the binding can be still expected even when the combination is not a perfectly matching one.

In its second fundamental aspect, the analytical method of the invention consists in a method of introducing a liquid sample and an analytical reagent separately, without mixing together, into an analytical device and is an analytical method comprising the following elements i) to iii).

It is an analytical method comprising the following elements i) to iv).

i) Preparing an analytical device comprising a passage allowing a liquid to flow therethrough as formed by bonding together a first member having a groove, 1 μm to 5 mm width and 1 μm to 750 μm depth in its cross-section, and a second member capable of covering the groove, together with a first nucleic acid (N1) having an arbitrary base sequence as immobilized in a capturing zone provided in the passage on the first member and/or second member prior to bonding the first member and second member together;

ii) Preparing a reagent A containing a conjugate (N2-L1) resulting from binding of a first ligand (L1) capable of specifically binding to a biological substance to be assayed to a second nucleic acid (N2) having a base sequence at least complementary to the base sequence of the first nucleic acid (N1);

iii) Introducing a liquid sample suspected of the occurrence therein of the biological substance (O) to be assayed and the reagent A individually, without preliminary mixing together, into the passage in the analytical device for the immobilization of the resulting conjugate within the passage;

iv) Assaying the immobilized conjugate.

The analytical method of the invention can also be applied as a method of analyzing a plurality of biological substance species. Thus, in a third fundamental aspect thereof, the analytical method of the invention consists in a method of introducing a mixture of a liquid sample and an analytical reagent into an analytical device and is a method comprising the following elements i) to iv).

i) Preparing an analytical device comprising a passage allowing a liquid to flow through the same as formed by bonding together a first member having a groove, 1 μm to 5 mm width and 1 μm to 750 μm depth in cross-section, and a second member capable of covering the groove, together with a plurality of first nucleic acid species (N1g: g being an integer) each having an arbitrary base sequence as immobilized each independently, from species to species, in a capturing zone provided in the passage on the first member and/or second member prior to bonding the first member and second member together;

ii) Preparing a reagent A containing a plurality of conjugate species (N2h-L1i: h and i each independently being an integer) each resulting from binding of one of a plurality of first ligand species (L1i: i being an integer), which is capable of specifically binding to the corresponding one among one or more biological substance species (Ok: k being an integer) to be assayed, to one of a plurality of second nucleic acid species (N2h: h being an integer) each having a sequence at least complementary to the base sequence of the corresponding one among the plurality of first nucleic acid species (N1g: g being an integer);

iii) Introducing a liquid sample suspected of the occurrence therein of one or more biological substance species (Ok: k being an integer) to be assayed and the reagent A, either after preliminary mixing thereof for conjugate formation or while allowing conjugate formation, into the passage in the analytical device for immobilizing the resulting one or more conjugates within the passage;

iv) Assaying the immobilized conjugate(s).

In a fourth fundamental aspect thereof, the analytical method of the invention consists in a method of introducing a liquid sample and an analytical reagent separately, without mixing together, into an analytical device and is an analytical method comprising the following elements i) to iv).

i) Preparing an analytical device comprising a passage allowing a liquid to flow through the same as formed by bonding together a first member having a groove, 1 μm to 5 mm width and 1 μm to 750 μm depth in cross-section, and a second member capable of covering the groove, together with a plurality of first nucleic acid species (N1g: g being an integer) each having an arbitrary base sequence as immobilized each independently, from species to species, in a capturing zone provided in the passage on the first member and/or second member prior to bonding the first member and second member together;

ii) Preparing a reagent A containing a plurality of conjugate species (N2h-L1i: h and i each independently being an integer) each resulting from binding of one of a plurality of first ligand species (L1i: i being an integer), which is capable of specifically binding to the corresponding one among one or more biological substance species (Ok: k being an integer) to be assayed, to one of a plurality of second nucleic acid species (N2h: h being an integer) each having a sequence at least complementary to the base sequence of the corresponding one among the plurality of first nucleic acid species (N1g: g being an integer);

iii) Introducing a liquid sample suspected of the occurrence therein of one or more biological substances (Ok: k being an integer) to be assayed and the reagent A individually into the passage in the analytical device for immobilizing the resulting one or more conjugates within the passage;

iv) Assaying the immobilized conjugate(s).

In the analytical methods mentioned above, a biological substance or substances can be assayed by introducing the reagent and a liquid sample into the analytical device for the immobilization in the form of a conjugate or conjugate species within the passage in the analytical device, causing a label or marker to bind to the conjugate or conjugate species formed and assaying the marker.

The analytical method of the invention can also be applied not only to the sandwich assay technology but also to assaying of various low-molecular to macromolecular compounds based on the competition principle.

The target of analysis by the analytical method of the invention is a biological substance and includes, as macromolecules, antigens, antibodies, sugar chains, glycoproteins, lectins, receptors, DNAs and RNAs and, further, substances capable of specifically binding to substances in the living body, without depending on the molecular weight of the substance to be assayed. The sample to be analyzed for such analysis targets includes blood, plasma, serum, urine, saliva, other body fluids, and materials containing at least one DNA, RNA, chromosome, DNA or RNA amplification product, antigen, antibody, sugar chain and/or receptor.

Analytical Device

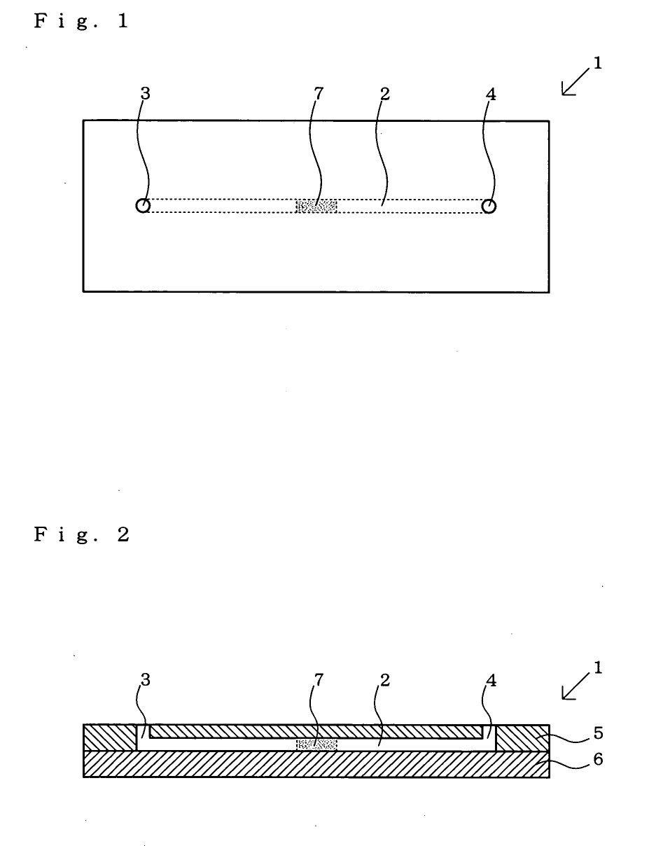

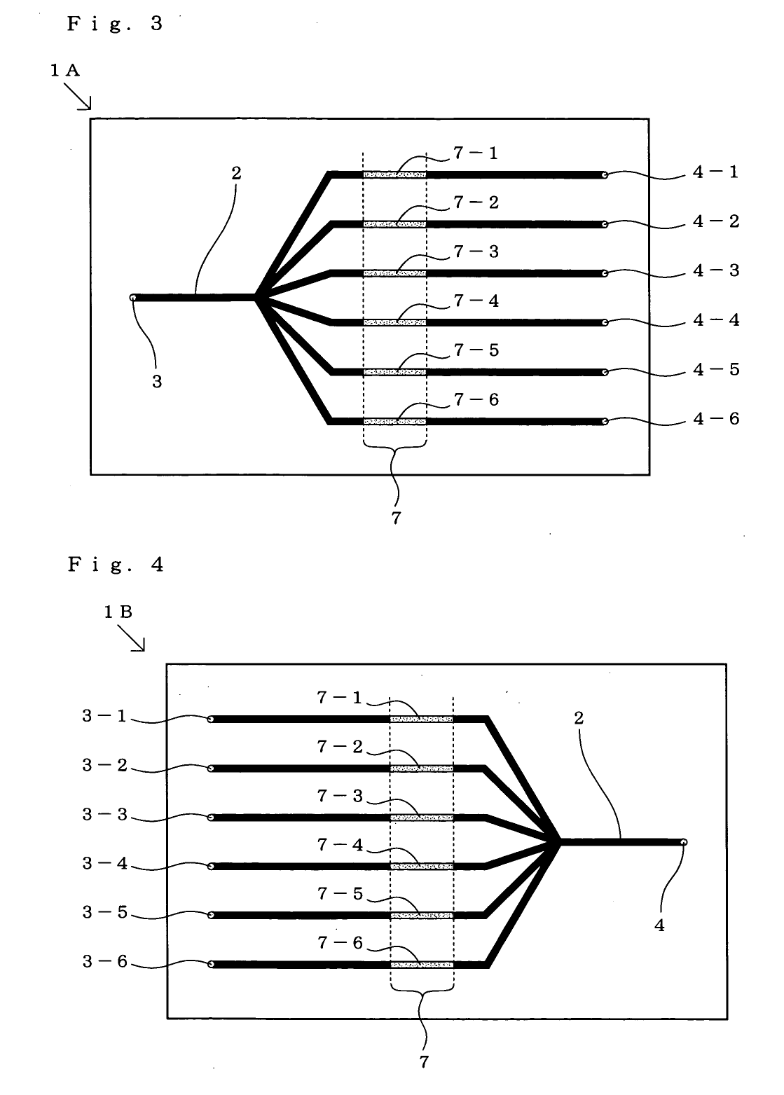

FIG. 1 is a plan view schematically illustrating an analytical device to be used in the practice of the invention, and FIG. 2 is a partial sectional view of the same. 1 indicates the analytical device which is constituted of a first member 5 and a second member 6 as bonded together. On the first member 5, there is formed a groove having, in its cross-section, a width of 1 μm to 5 mm, preferably 5 μm to 2 mm, most preferably 10 μm to 500 μm, and a depth of 1 μm to 750 μm, preferably 5 μm to 500 μm, most preferably 10 μm to 100 μm and, upon bonding to the second member 6, the groove forms a passage 2. A passage inlet 3 is provided at one end of the passage and a passage outlet 4 at the other end. It is also possible to provide, between the passage inlet and outlet, one or more inlets for introducing the reagent and/or sample or provide another passage connected to such passage according to the intended purpose. In the passage 2, there is provided a capturing zone 7 for capturing and analyzing a biological substance.

FIG. 3 illustrates an embodiment of the analytical device in which there is one passage inlet, the passage branches on its way into a plurality of passages and there are a plurality of passage outlets. In the analytical device 1A shown in FIG. 3, capturing zones 7-1, 7-2, 7-3, 7-4, 7-5 and 7-6 for capturing and analyzing a biological substance(s) are provided in the plurality of respective passages branching from one passage 2 and, in the passage system, there are provided one passage inlet 3 and a plurality of passage outlets 4-1, 4-2, 4-3, 4-4, 4-5 and 4-6.

FIG. 4 illustrates an embodiment of the analytical device in which there are a plurality of passage inlets, the corresponding plurality of passages gather on their way to form one passage and there is only one passage outlet. In the analytical device 1B shown in FIG. 4, capturing zones 7-1, 7-2, 7-3, 7-4, 7-5 and 7-6 for capturing and analyzing a biological substance(s) are provided in the plurality of respective passages 2 and, in the passage system, there are provided a plurality of passage inlets 3-1, 3-2, 3-3, 3-4, 3-5 and 3-6 and one passage outlet 4.

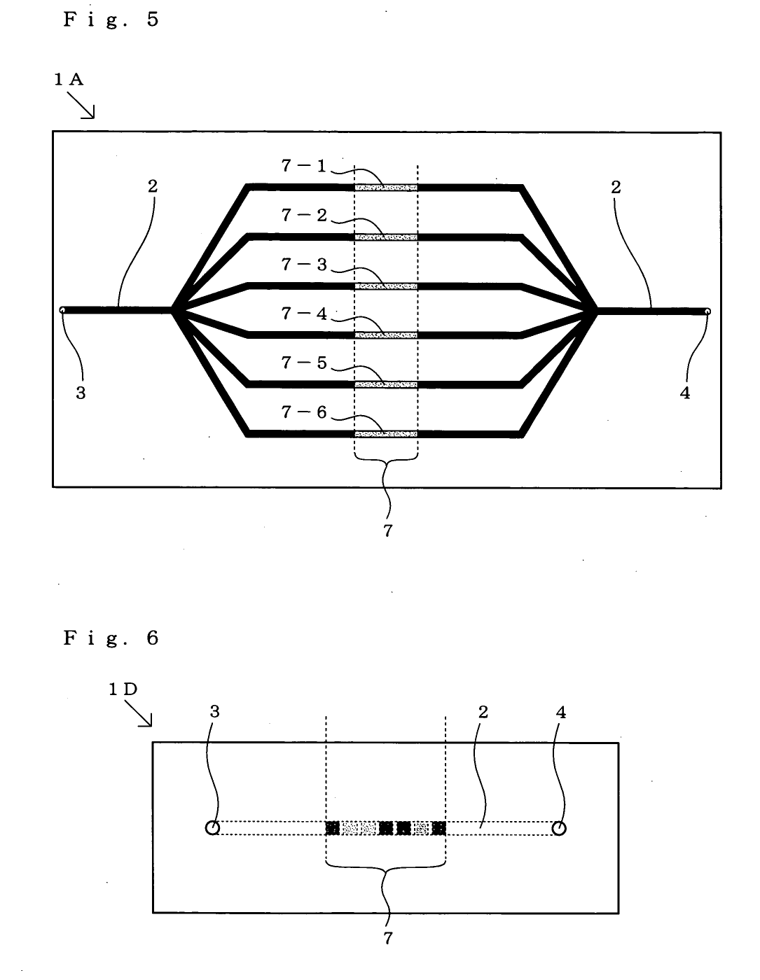

FIG. 5 shows an embodiment of the analytical device in which there is one passage inlet, the passage branches on its way into a plurality of passages, which further gather on their way to form one passage, and there is one passage outlet. In the analytical device 1C shown in FIG. 5, capturing zones 7-1, 7-2, 7-3, 7-4, 7-5 and 7-6 for capturing and analyzing a biological substance(s) are provided in the plurality of respective passages branching from one passage 2, there is one passage inlet 3 provided in the passage before branching and there is one passage outlet 4 provided in the passage after convergence.

FIG. 6 shows an embodiment of the analytical device for analyzing one or more biological substance species in which device there are one passage inlet and one passage outlet. In the capturing zone for capturing a biological substance(s) contained in a sample, there are immobilized first nucleic acid species (N1g: g being an integer) for capturing a conjugate(s) containing the biological substance(s) independently from species to species.

In analytical devices of the types shown in FIG. 3, FIG. 4 and FIG. 5 as explained above which have a plurality of passages, first nucleic acid species (N1g: g being an integer) for capturing conjugate species containing different biological substance species may be immobilized in each capturing zone provided in each passage, or the first nucleic acid species (N1g: g being an integer) may be immobilized each independently in each respective capturing zone. A plurality of first nucleic acid species (N1g: g being an integer) may be immobilized in admixture in each capturing zone. It is of course possible to immobilize one and the same first nucleic acid (N1) in a plurality of capturing zones. It is also possible to provide, between the one or more passage inlets and outlets, one or more inlets for introducing the reagent and/or sample or provide another passage connected to such passages according to the intended purpose.

The cross-section of the passage 2 to be formed within the analytical device 1 according to the invention may be square, rectangular, polygonal, semicircular, ark-like, U-shaped or V-shaped.

Usable as the material of the first member 5 and second member 6 are, among others, polydimethylsiloxane (PDMS: abbreviation; Anal. Chem., Vol. 69, pp. 3451-3457, 1997), acrylic resins (Anal. Chem., Vol. 69, pp. 2626, 1997), polymethyl methacrylate (PMMA: abbreviation; Anal. Chem., Vol. 69, pp. 4783, 1997), glass, cyclic olefin copolymers, or substances derived from these materials by surface modification with diamond or diamond-like carbon (JP-A No. 2002-365293), cetyltrimethylammonium bromide (CTAB), Surmodics, Reacti-Bind (Analytical Chemistry, 317 (2003) 76-84), poly-L-lysine, carbodiimide, amino group, aldehyde group, maleimide group, dextran etc.

The first member and second member can be produced, for example, in the following manner. First, a mold is prepared by etching of a silicon wafer. A molten polymer is poured into the mold for structure transfer and the polymer is allowed to solidify. By this transfer, a groove passage having, in its cross-section, a width of 1 μm to 5 mm, preferably 5 μm to 2 mm, most preferably 10 μm to 500 μm, and a depth of 1 μm to 750 μm, preferably 5 μm to 500 μm, most preferably 10 μm to 100 μm, and an analytical device member with an effective length for analysis of several millimeters to scores of centimeters is formed. When PDMS is used as the raw material, passage sealing can be realized in a simple manner owing to spontaneous adsorption between glass or the like and PDMS. Mass production of microchannels using a plastic is easy and advantageous from the cost viewpoint. In the case of glass, the depth must be adjusted by selecting the time of reaction with hydrogen fluoride, whereas, in the case of plastics, high-reproducibility production is possible by the injection molding technology once a mold is prepared.

Analytical Kit

The analytical kit of the invention for solving the problems mentioned hereinabove includes the following first to tenth analytical kits.

The first analytical kit according to the invention in which a reagent set and an analytical device are independent from each other is an analytical kit comprising a combination of the following reagent A and reagent B and analytical device, in which the reagent A and reagent B may be contained in the same system or may occur independently from each other. Thus, the analytical device to be used in the first analytical kit of the invention is an analytical device comprising a passage allowing a liquid to flow through the same as formed by bonding together a first member having a groove, 1 μm to 5 mm width and 1 μm to 750 μm depth in its cross-section, and a second member capable of covering the groove, together with a first nucleic acid (N1) having an arbitrary base sequence as immobilized in a capturing zone provided in the passage on the first member and/or second member prior to bonding the first member and second member together. The reagent A to be used in the first analytical kit of the invention is a reagent containing a conjugate (N2-L1) composed of a second nucleic acid (N2) having a sequence at least complementary to the base sequence of the first nucleic acid (N1) immobilized in the capturing zone of the analytical device and a first ligand (L1) capable of specifically binding to a biological substance (O) to be assayed. The reagent B to be used in the first analytical kit of the invention is a reagent containing a conjugate (L2-M) resulting from binding between a second ligand (L2) capable of specifically binding to the biological substance (O) to be assayed and a label or marker (M).

By saying “the reagent A and reagent B are contained in the same system” referring to the analytical kits described herein, it is meant that the reagent A and reagent B are in a state uniformly mixed together and, by saying “the reagent A and reagent B occur independently from each other”, it is means that the reagent A and reagent B are in a state separated from each other as individuals.

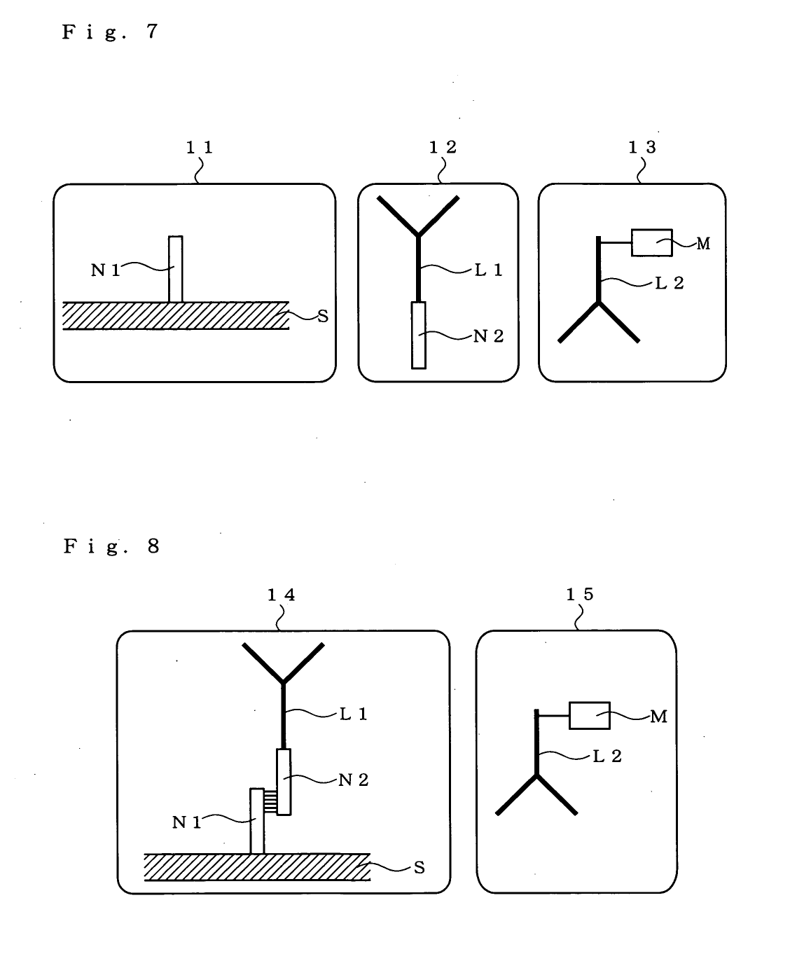

FIG. 7 schematically illustrates the first analytical kit of the invention. Thus, it shows an example in which the first ligand (L1) and second ligand (L2) are antibodies and the analytical device, first reagent and second reagent occur each independently. By framing, it is meant that each framed component occurs independently, namely that it is a separate body and can be used in a separated state. In FIG. 7, 11 shows only the capturing zone in the passage in the analytical device; it is a figure showing a state such that the first nucleic acid (N1) is immobilized on a solid phase (S). In FIG. 7, 12 is a figure showing the reagent A containing the conjugate (N2-L1) resulting from binding of the antibody as the first ligand (L1) to the second nucleic acid (N2). In FIG. 7, 13 is a figure showing the reagent B containing the conjugate (L2-M) resulting from binding of a marker (M) to the antibody as the second ligand (L2).

The mode of binding between the marker (M) and second ligand (L2) is applicable not only to the first analytical kit of the invention but also to all the analytical kits according to the invention. While, in FIG. 7, the reagent A12 and reagent B13 are shown in different frames, indicating that they occur independently, the reagent A12 and reagent B13 may be in the same frame and in a state uniformly mixed up, namely in the same system, in a mode of embodiment different from that shown in FIG. 7.

The second analytical kit of the invention is such that the following reagent B′ and reagent C are used in lieu of the reagent B containing the conjugate (L2-M) resulting from binding of the marker (M) to the second ligand (L2: antibody) as used in the first analytical kit described above. Thus, the second analytical kit of the invention is an analytical in which a reagent set and an analytical device are independent from each other and which comprises a combination of the following reagent A, reagent B′ and reagent C and analytical device, in which kit two or more of the reagent A, reagent B′ and reagent C may be contained in the same system or the reagents may occur each independently.

i) An analytical device comprising a passage allowing a liquid to flow through the same as formed by bonding together a first member having a groove, 1 μm to 5 mm width and 1 μm to 750 μm depth in its cross-section, and a second member capable of covering the groove, together with a first nucleic acid (N1) having an arbitrary base sequence as immobilized in a capturing zone provided in the passage on the first member and/or second member prior to bonding the first member and second member together;

ii) A reagent A containing a conjugate (N2-L1) composed of a second nucleic acid (N2) having a sequence at least complementary to the base sequence of the first nucleic acid (N1) immobilized in the capturing zone of the analytical device and a first ligand (L1) capable of specifically binding to a biological substance (O) to be assayed;

iii) A reagent B′ containing a second ligand (L2) capable of specifically binding to the biological substance (O) to be assayed; and

iv) A reagent C containing a conjugate (L3-M) composed of a third ligand (L3) capable of specifically binding to the second ligand (L2) and a marker (M).

The third analytical kit of the invention is a kit comprising a reagent and analytical device as individual units and containing no marker. It is not necessary for the third analytical kit of the invention to include any marker as a constituent element thereof since the target of analysis is a biological substance having a marker introduced therein beforehand.

i) An analytical device comprising a passage allowing a liquid to flow through the same as formed by bonding together a first member having a groove, 1 μm to 5 mm width and 1 μm to 750 μm depth in its cross-section, and a second member capable of covering the groove, together with a first nucleic acid (N1) having an arbitrary base sequence as immobilized in a capturing zone provided in the passage on the first member and/or second member prior to bonding the first member and second member together; and

ii) A reagent A containing a conjugate (N2-L1) composed of a second nucleic acid (N2) having a sequence at least complementary to the base sequence of the first nucleic acid (N1) immobilized in the capturing zone of the analytical device and a first ligand (L1) capable of specifically binding to a biological substance (O) to be assayed.

The fourth analytical kit of the invention is a kit in which a part of the reagents, namely a ligand capable of specifically binding to a biological substance is immobilized in the analytical device. Thus, the fourth analytical kit of the invention is an analytical kit in which the reagent and analytical device form individual units and which comprises a combination of the following reagent B and analytical device.

i) An analytical device comprising a passage allowing a liquid to flow through the same as formed by bonding together a first member having a groove, 1 μm to 5 mm width and 1 μm to 750 μm depth in its cross-section, and a second member capable of covering the groove, together with a first nucleic acid (N1) having an arbitrary base sequence as immobilized in a capturing zone provided in the passage on the first member and/or second member prior to bonding the first member and second member together, and further together with a conjugate (N2-L1) composed of a first ligand (L1) capable of specifically binding to a biological substance (O) to be assayed and a second nucleic acid (N2) having a base sequence at least complementary to the immobilized first nucleic acid (N1) as formed and immobilized in the capturing zone in form of a conjugate (N1-N2-L1) by specific binding between the first nucleic acid (N1) and second nucleic acid (N2); and

ii) A reagent B containing a conjugate (L2-M) resulting from binding between a second ligand (L2) capable of specifically binding to the biological substance (O) to be assayed and a marker (M).

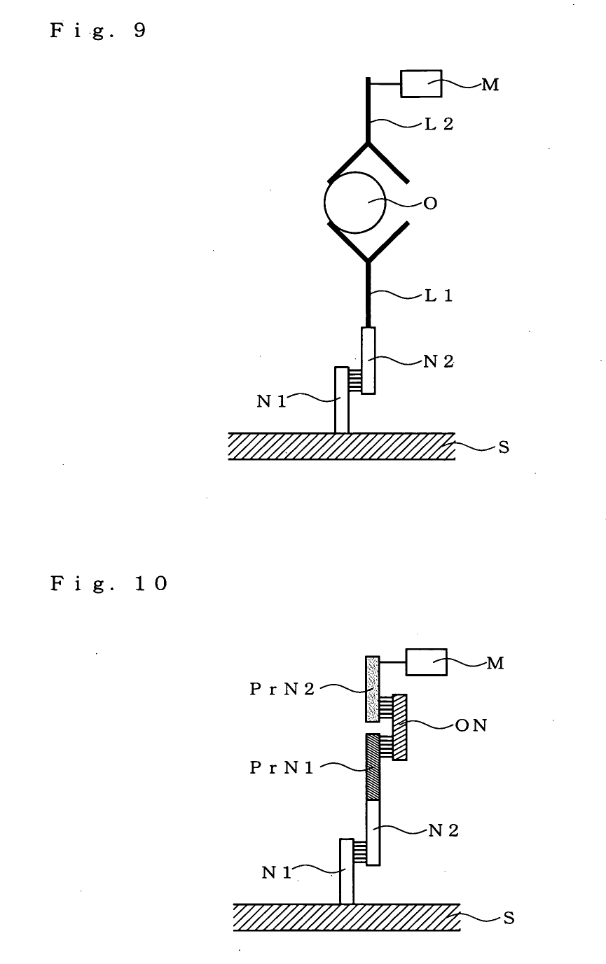

FIG. 8 is a schematic representation of the fourth analytical kit of the invention and shows, in particular, an analytical kit in the case of the first ligand (L1) and second ligand (L2) being antibodies. In FIG. 8, 14 indicates the analytical device, with the capturing zone in the passage in the analytical device alone being shown, and shows a state in which the first nucleic acid (N1) is immobilized on a solid phase (S) and the conjugate (N2-L1) composed of the second nucleic acid (N2) and first ligand (L1) is bound to the first nucleic acid (N1) by specific binding between complementary nucleic acid bases. In FIG. 8, 15 indicates the reagent B containing the conjugate (L2-M) resulting from binding of the marker (M) to the second ligand (L2: antibody).

The fifth analytical kit of the invention uses the following reagent B′ and reagent C in lieu of the reagent B containing the conjugate (L2-M) resulting from binding of the marker (M) to the second ligand (L2) as used in the above-mentioned fourth analytical kit. Thus, the fifth analytical kit of the invention in which the reagents and analytical device constitute separate units is an analytical kit comprising the following reagent A, reagent B′, reagent C and analytical device, in which kit two or more of the reagent A, reagent B′ and reagent C may be contained in the same system or the reagents may occur each independently.

i) An analytical device comprising a passage allowing a liquid to flow through the same as formed by bonding together a first member having a groove, 1 μm to 5 mm width and 1 [m to 750 μm depth in its cross-section, and a second member capable of covering the groove, together with a first nucleic acid (N1) having an arbitrary base sequence as immobilized in a capturing zone provided in the passage on the first member and/or second member prior to bonding the first member and second member together, and further together with a conjugate (N2-L1) composed of a first ligand (L1) capable of specifically binding to a biological substance (O) to be assayed and a second nucleic acid (N2) having a base sequence at least complementary to the immobilized first nucleic acid (N1) as formed and immobilized in the capturing zone by specific binding between the first nucleic acid (N1) and second nucleic acid (N2); and

ii) A reagent B′ containing a second ligand (L2) capable of specifically binding to the biological substance (O) to be assayed; and

iii) A reagent C containing a conjugate (L3-M) composed of a third ligand (L3) capable of specifically binding to the second ligand (L2) and a marker (M).

The sixth analytical kit of the invention is a modification based on the constitution of the above-mentioned first analytical kit as made so that one or more biological substance species can be analyzed. Thus, the sixth analytical kit of the invention in which the reagents and analytical device constitute individual units is an analytical kit comprising a combination of the following reagent A, reagent B and analytical device, in which kit the reagent A and reagent B may be contained in the same system or occur each independently.

i) An analytical device comprising a passage allowing a liquid to flow through the same as formed by bonding together a first member having a groove, 1 μm to 5 mm width and 1 μm to 750 μm depth in its cross-section, and a second member capable of covering the groove, together with a plurality of first nucleic acid species (N1g: g being an integer) each having an arbitrary base sequence as immobilized each independently, from species to species, in a capturing zone provided in the passage on the first member and/or second member prior to bonding the first member and second member together;

ii) A reagent A containing a plurality of conjugate species (N2h-L1i: h and i each independently being an integer) each composed of one of a plurality of second nucleic acid species (N2h: h being an integer) each having a sequence at least complementary to the base sequence of the corresponding one among the plurality of first nucleic acid species (N1g: g being an integer) immobilized in the capturing zone and one of a plurality of first ligand species (L1i: i being an integer) which is capable of specifically binding to the corresponding one among one or more biological substance species (Ok: k being an integer) to be assayed; and

iii) A reagent B containing conjugate species (L2j-M1: j and 1 each independently being an integer) resulting from binding between one or more second ligand species (L2j: j being an integer) capable of specifically binding to the corresponding one or more biological substance species (Ok: k being an integer) to be assayed and one or more marker species (M1: 1 being an integer).

The phrase “plurality of first nucleic acid species (N1g: g being an integer)” as used herein means a plurality of first nucleic acid species including N11, N12, . . . , and N1g (g: being an integer). Similarly, the phrase “plurality of second nucleic acid species (N2h: h being an integer)” means a plurality of second nucleic acid species including N21, N22, . . . , and N2h (h being an integer). The suffix i used in the phrase “plurality of first ligand species (L1i: i being an integer)”, the suffix j used in the phrase “one or more second ligand species (L2j: j being an integer)”, the suffix k used in the phrase “one or more biological substance species (Ok: k being an integer)” and the suffix 1 used in the phrase “one or more marker species (M1: 1 being an integer)” also mean that there are one or more or a plurality of the corresponding substance species, like species 1, species 2, . . .

The seventh analytical kit of the invention is a modification based on the constitution of the above-mentioned second analytical kit as made so that one or more biological substance species can be analyzed. It is an analytical kit in which second ligand species (reagent B′) and third ligand-marker species (reagent C) are used in lieu of the second ligand-marker conjugate species (reagent B) in the sixth analytical kit. Thus, the seventh analytical kit of the invention in which the reagents and analytical device constitute individual units is an analytical kit comprising a combination of the following reagent A, reagent B′, reagent C and analytical device, in which kit two or more of the reagent A, reagent B′ and reagent C may be contained in the same system or the reagents may occur each independently.

i) An analytical device comprising a passage allowing a liquid to flow through the same as formed by bonding together a first member having a groove, 1 μm to 5 mm width and 1 μm to 750 μm depth in its cross-section, and a second member capable of covering the groove, together with a plurality of first nucleic acid species (N1g: g being an integer) each having an arbitrary base sequence as immobilized each independently, from species to species, in a capturing zone provided in the passage on the first member and/or second member prior to bonding the first member and second member together;

ii) A reagent A containing a plurality of conjugate species (N2h-L1i: h and i each independently being an integer) each composed of one of second nucleic acid species (N2h: h being an integer) each having a sequence at least complementary to the base sequence of the corresponding one among the plurality of first nucleic acid species (N1g: g being an integer) immobilized in the capturing zone and one of a plurality of first ligand species (L1i: i being an integer) which is capable of specifically binding to the corresponding one among one or more biological substance species (Ok: k being an integer) to be assayed;

iii) A reagent B′ containing one or more second ligand species (L2j: j being an integer) each capable of specifically binding to the corresponding one among the one or more biological substance species (Ok: k being an integer) to be assayed; and iv) A reagent C containing conjugate species (L3m-M1: m and 1 each independently being an integer) composed of one or more third ligand species (L3m: m being an integer) capable of specifically binding to the corresponding one among the one or more second ligand species (L2j: j being an integer) and one or more marker species (M1: 1 being an integer).

The eighth analytical kit of the invention is a modification based on the constitution of the above-mentioned third analytical kit as made so that one or more biological substance species can be analyzed. The eighth analytical kit of the invention is an analytical kit for a plurality of assay targets each having a marker introduced therein and therefore contains no marker. Thus, the eighth analytical kit of the invention is an analytical kit comprising the following reagent A and analytical device in which the reagent and analytical device occur as separate units.

i) An analytical device comprising a passage allowing a liquid to flow through the same as formed by bonding together a first member having a groove, 1 μm to 5 mm width and 1 μm to 750 μm depth in its cross-section, and a second member capable of covering the groove, together with a plurality of first nucleic acid species (N1g: g being an integer) each having an arbitrary base sequence as immobilized each independently, from species to species, in a capturing zone provided in the passage on the first member and/or second member prior to bonding the first member and second member together;

ii) A reagent A containing a plurality of conjugate species (N2h-L1i: h and i each independently being an integer) each composed of one of a plurality of second nucleic acid species (N2h: h being an integer) each having a sequence at least complementary to the base sequence of the corresponding one among the plurality of first nucleic acid species (N1g: g being an integer) immobilized each independently, from species to species, in the capturing zone of the analytical device and one of a plurality of first ligand species (L1i: i being an integer) which is capable of specifically binding to the corresponding one among one or more biological substance species (Ok: k being an integer) to be assayed.

The ninth analytical kit of the invention is a modification based on the constitution of the above-mentioned fourth analytical kit as made so that one or more biological substance species can be analyzed. The ninth analytical kit of the invention is a kit in which ligands capable of specifically binding to the biological substance species and serving as a part of reagents are immobilized in the analytical device and in which the reagent and analytical device occur as separate units. It is an analytical kit comprising a combination of the following reagent B and analytical device.

i) An analytical device comprising a passage allowing a liquid to flow through the same as formed by bonding together a first member having a groove, 1 μm to 5 mm width and 1 μm to 750 μm depth in its cross-section, and a second member capable of covering the groove, together with a plurality of first nucleic acid species (N1g: g being an integer) each having an arbitrary base sequence as immobilized each independently, from species to species, in a capturing zone provided in the passage on the first member and/or second member prior to bonding the first member and second member together, and further together with conjugate species (N2h-L1i: h and i each independently being an integer) each composed of one of a plurality of first ligand species (L1i: i being an integer) which is capable of specifically binding to the corresponding one among one or more biological substance species (Ok: k being an integer) to be assayed and one of a plurality of second nucleic acid species (N2h: h being an integer), which has a base sequence at least complementary to the corresponding one among the immobilized first nucleic acid species (N1g: g being an integer), as formed and immobilized in the capturing zone by specific binding between the first nucleic acid species and second nucleic acid species; and ii) A reagent B containing conjugate species (L2j -M1: j and 1 each independently being an integer) resulting from binding between one or more second ligand species (L2j: j being an integer) respectively capable of specifically binding to the corresponding one or more biological substance species to be assayed and one or more marker species (M1: 1 being an integer).

The tenth analytical kit of the invention is a modification based on the constitution of the above-mentioned fifth analytical kit as made so that one or more biological substance species can be analyzed. The tenth analytical kit of the invention is a kit in which ligands capable of specifically binding to the biological substance species and serving as a part of reagents are immobilized in the analytical device and in which the reagents and analytical device occur as separate units, and is an analytical kit comprising a combination of the following reagent B′, reagent C and analytical device.

i) An analytical device comprising a passage allowing a liquid to flow through the same as formed by bonding together a first member having a groove, 1 μm to 5 mm width and 1 μm to 750 μm depth in its cross-section, and a second member capable of covering the groove, together with a plurality of first nucleic acid species (N1g: g being an integer) each having an arbitrary base sequence as immobilized each independently, from species to species, in a capturing zone provided in the passage on the first member and/or second member prior to bonding the first member and second member together, and further together with conjugate species (N2h-L1i: h and i each independently being an integer) each composed of one of a plurality of first ligand species (L1i: i being an integer) which is capable of specifically binding to the corresponding one among one or more biological substance species (Ok: k being an integer) to be assayed and one of a plurality of second nucleic acid species (N2h: h being an integer), which has a base sequence at least complementary to the corresponding one among the immobilized first nucleic acid species (N1g: g being an integer), as formed and each independently immobilized in the capturing zone by specific binding between the first nucleic acid species and second nucleic acid species; and

ii) A reagent B′ containing one or more second ligand species (L2j: j being an integer) capable of specifically binding to the corresponding one among the one or more biological substance species (Ok: k being an integer) to be assayed;

iii) A reagent C containing conjugate species (L3m-M1: m and 1 each independently being an integer) derived from one or more third ligand species (L3m: m being an integer) capable of specifically binding to the corresponding one among the one or more second ligand species (L2j: j being an integer) and one or more marker species (M1: 1 being an integer).

The first ligand (L1 or L1i:i being an integer), optionally the second ligand (L2 or L2j:j being an integer), and the third ligand species (L3 or L3m: m being an integer), which are to be contained in the analytical kits of the invention, are selected from among immunological substances, receptors, receptor-binding substances, sugars, glycoproteins, glycolipids, lectins and nucleic acid species. As the nucleic acid species which can be used in constituting the analytical kits of the invention, there may be mentioned DNA, RNA, PNA (FASEB J. Jun. 14, 2000(9):1041-60 (Non-Patent Document 4)) or LNA (abbreviation for Locked Nucleic Acid; J. Biomol. Struct. Dyn. Oct. 17, 1999(2);175-191 (Non-Patent Document 5)) species comprising 5 or more nucleic acid bases.

The first ligand (L1) and second ligand (L2) contained in the corresponding analytical kits of the invention may be identical of different in reactivity. When the first ligand (L1) and second ligand (L2) are antibodies and the biological substance to be assayed is an antigen, for instance, the first ligand (L1) and second ligand (L2) may be reactive either with different epitopes occurring in the one and same biological substance or with the same epitope.

When the analysis target is a nucleic acid, too, the same analytical kits as the above-mentioned analytical kits can be constructed. More specifically, analytical kits for assaying nucleic acid species, which have the same constitution as the analytical kits mentioned above, can be constructed by using a first probe nucleic acid (PrN1) containing a base sequence at least complementary to a nucleic acid to be assayed as the first ligand (L1) in the analytical kits mentioned above and, as the second ligand (L2), a second probe nucleic acid (PrN2) capable of binding to the nucleic acid at a site different from the site of binding of the first probe nucleic acid (PrN1).

The marker (M) to be used in the analytical kits of the invention includes fluorescent substances, colloidal metals, enzymes, nucleic acids, metals, sugars, lectins, biotin, and biotin-binding substances (streptavidin, avidin, NeutrAvidin). The one or more marker species (M1: 1 being an integer) to be bound to the second ligand species or third ligand species in the analytical kits of the invention for assaying one or more biological substance species may be the same or different substances.

The analytical device for analyzing or assaying, as an analysis target, a biological substance with a marker already introduced therein, when it is an analytical device with the reagent immobilized in a capturing zone in the passage or channel of the analytical device, can be constructed without using the reagent as a separate unit. Such analytical device for biological substances is an analytical device comprising a passage allowing a liquid to flow through the same as formed by bonding of a first member having a groove, 1 μm-5 mm width and 1 μm-750 μm depth in cross-section, to a second member capable of covering the groove as well as a first nucleic acid (N1) having an arbitrary base sequence as immobilized in a capturing zone provided in the passage on the first member and/or second member prior to bonding the first member and second member together, and further comprising a conjugate (N2-L1) composed of a first ligand (L1) capable of specifically binding to a biological substance (O) to be assayed and a second nucleic acid (N2) having an at least complementary sequence to the immobilized first nucleic acid as immobilized in the capturing zone by specific binding between the first nucleic acid (N1) and second nucleic acid (N2). Since the analysis target is a biological substance with a marker introduced therein, the analytical device does not require the use of a reagent but can be applied in one of the analytical methods described in detail later herein.

Further, an analytical device for assaying one or more biological substance species to serve as analytical targets with a marker introduced therein can be constituted in the following manner. Thus, the analytical device comprises a passage allowing a liquid to flow through the same as formed by bonding a first member having a groove, 1 μm-5 mm width and 1 μm-750 μm depth in cross-section, to a second member capable of covering the groove as well as a plurality of first nucleic acid species (N1g: g being an integer) each having an arbitrary base sequence as immobilized each independently, from species to species, in a capturing zone provided in the passage on the first member and/or second member prior to bonding the first member and second member together and said device further comprises conjugate species (N2h-L1i: h and i each independently being an integer) each composed of one of a plurality of first ligand species (L1i: i being an integer) capable of specifically binding to the corresponding one among one or more biological substance species (Ok: k being an integer) to be assayed and one of a plurality of second nucleic acid species (N2h: h being an integer) having an at least complementary sequence to the corresponding one among the immobilized first nucleic acid species (Nig: g being an integer) as immobilized in the capturing zone independently, from species to species, by specific binding between the first nucleic acid species (N1g: g being an integer) and second nucleic acid species (N2h: h being an integer).

As for the method of binding a DNA to a site to be a capturing zone in a place to form the passage on the first member and/or second member in the analytical devices to be used in the analytical kits of the invention or in the analytical devices of the invention, the method comprising causing a drop of a nucleic acid-containing liquid to stick to the solid phase be means of a thermal ink jet head to thereby immobilize the nucleic acid (JP-A No. H11-187900 (Patent Document 7)), the Affymetrix method comprising arranging a plurality of oligonucleotides side by side on a support such as silicon by the photolithographic method for spot formation (U.S. Pat. No. 5,445,934 (Patent Document 8) etc.), or the Stanford method comprising arranging a number of nucleic acid species side by side on a slide glass for immobilization of the same (U.S. Pat. No. 5,807,522 (Patent Document 9)), for instance, can be applied in manufacturing the analytical devices according to the invention.

In the analytical devices to be used in the practice of the present invention, a solution containing the conjugate (N2-L1), which is composed of a second nucleic acid (N2) having a base sequence at least complementary to the base sequence of the first nucleic acid (N1) and a first ligand (L1), is fed to the passage, in which there is the first nucleic acid (N1) immobilized, for the immobilization of the conjugate through specific binding to the first nucleic acid (N1) and, therefore, the step of immobilization of the conjugate (N2-L1) can be carried out after bonding the first member to the second member together. Thus, the step of immobilization of the conjugate (N2-L1) is carried out after bonding the first member and second member together and, therefore, when the first ligand (L1) is an antibody or protein or a like substance readily susceptible to inactivation by heat or an adhesive, the influence of heat or the adhesive on the occasion of bonding the first member and second member together will advantageously never be exerted on the first ligand (L1).

In the analytical devices to be used in the invention, the immobilized first nucleic acid (N1) and the conjugate (N2-L1), which is composed of a second nucleic acid (N2) and a first ligand (L1) and is to be subsequently immobilized, are materials prepared separately and, therefore, once an analytical device with a first nucleic acid (N1) immobilized therein is produced, it is possible to prepare various conjugate species (N2-L1i: i being an integer) using various kinds of first ligand species, select one of the conjugate species (N2-L11), (N2-L12), . . . , (N2-L1n), which is capable of specifically binding to the biological substance to be assayed, according to the kind thereof, and immobilize the same by binding the same to the immobilized first nucleic acid (N1). Therefore, if various conjugate species (N2-L11), (N2-L12), . . . , (N2-L1i: i being an integer) each composed of a second nucleic acid and a first ligand are prepared in advance according to the kinds of biological substance species, analytical devices of one and the same kind with a first nucleic acid (N1) immobilized therein can be used in carrying out assays corresponding to a infinite number of biological substance species, or the analytical devices to be used in the invention can be prepared by a simple and easy process, without carrying out a production process consisting of a multiple individual steps for producing specialized analytical devices for specific use for respective biological substance species.

Methods of Analysis

In the present specification, the term “analysis” or “assaying” means confirming the presence or absence of a target of analysis or determining the quantity thereof.

The four fundamental methods of analysis according to the invention are as described herein above. More specific modes of the analytical methods of the invention are given below.

The first analytical method of the invention which uses the first analytical kit described above (namely the kit comprising the reagent A, reagent B and analytical device) comprises mixing up two or more of the reagent A, sample and reagent B in advance, introducing the mixture into the analytical device, and then introducing the remaining material, if any. Thus, the first analytical method of the invention which uses the first analytical kit comprises the following elements i) to iv):

i) Using the first analytical kit described above;

ii) Introducing arbitrary two or more of the materials a, b and c given below, either after preliminary mixing thereof for conjugate formation or while allowing conjugate formation, into the passage in the analytical device contained in the analytical kit, followed by introduction of the remaining material, if any, into the passage:
a. A liquid sample suspected of the occurrence therein of a biological substance (O) to be assayed,
b. A reagent A containing a conjugate (N2-L1) composed of a second nucleic acid (N2) having a base sequence at least complementary to the base sequence of the first nucleic acid (N1) immobilized in the capturing zone and a first ligand (L1) capable of specifically binding to the biological substance (O) to be assayed,
c. A reagent B containing a conjugate (L2-M) resulting from direct binding of a marker (M) to a second ligand (L2) capable of specifically binding to the biological substance (O) to be assayed;

iii) Allowing the formation of an immobilized conjugate (N1-N2-L1-O-L2-M) by specific binding between the first nucleic acid (N1) immobilized in the capturing zone in the analytical device and the second nucleic acid (N2), specific binding between the first ligand (L1) and the biological substance (O) and specific binding between the second ligand (L2) and the biological substance (O);

iv) Assaying the biological substance (O) by assaying the marker (M) contained in the immobilized conjugate (N1-N2-L1-O-L2-M).

The second analytical method of the invention which uses the first analytical kit (namely the kit comprising the reagent A, reagent B and analytical device) comprises introducing the reagent A, sample and reagent B individually into the analytical device in an arbitrary order without any preliminary mixing thereof. Thus, the second analytical method of the invention which uses the first analytical device comprises the following elements i) to iv):

i) Using the first analytical kit described above;

ii) Introducing the following materials a, band c given below individually, without mixing together, into the passage in the analytical device contained in the analytical kit:
a. A liquid sample suspected of the occurrence therein of a biological substance (O) to be assayed,
b. A reagent A containing a conjugate (N2-L1) composed of a second nucleic acid (N2) having a base sequence at least complementary to the base sequence of the first nucleic acid (N1) immobilized in the capturing zone and a first ligand (L1) capable of specifically binding to the biological substance (O) to be assayed,
c. A reagent B containing a conjugate (L2-M) resulting from direct binding of a marker (M) to a second ligand (L2) capable of specifically binding to the biological substance (O) to be assayed;

iii) Allowing the formation of an immobilized conjugate (N1-N2-L1-O-L2-M) by specific binding between the first nucleic acid (N1) immobilized in the capturing zone in the analytical device and the second nucleic acid (N2), specific binding between the first ligand (L1) to the biological substance (O) and specific binding between the second ligand (L2) and the biological substance (O);

iv) Assaying the biological substance (O) by assaying the marker (M) contained in the immobilized conjugate (N1-N2-L1-O-L2-M).

The first analytical method of the invention, when it uses the second analytical kit described above (namely the kit comprising the reagent A, reagent B′, reagent C and analytical device), comprises mixing up two or more of the liquid sample, reagent A, reagent B′ and reagent C in advance, introducing the mixture into the analytical device, followed by introduction of the remaining material (s), if any. Thus, the first analytical method of the invention which uses the second analytical kit comprises the following elements i) to iv):

i) Using the second analytical kit described above;

ii) Introducing arbitrary two or more of the materials a, b, c and d given below, either after preliminary mixing thereof for conjugate formation or while allowing conjugate formation, into the passage in the analytical device contained in the analytical kit, followed by introduction of the remaining material or materials, if any, into the passage:
a. A liquid sample suspected of the occurrence therein of a biological substance (O) to be assayed,
b. A reagent A containing a conjugate (N2-L1) composed of a second nucleic acid (N2) having a base sequence at least complementary to the base sequence of the first nucleic acid (N1) immobilized in the capturing zone and a first ligand (L1) capable of specifically binding to the biological substance (O) to be assayed,
c. A reagent B′ containing a second ligand (L2) capable of specifically binding to the biological substance (O) to be assayed, and
d. A reagent C containing a conjugate (L3-M) composed of a third ligand (L3) capable of specifically binding to the second ligand (L2) and a marker (M);
iii) Allowing the formation of an immobilized conjugate (N1-N2-L1-O-L2-L3-M) by specific binding between the first nucleic acid (N1) immobilized in the capturing zone in the analytical device and the second nucleic acid (N2), specific binding between the first ligand (L1) to the biological substance (O), specific binding between the second ligand (L2) and the biological substance (O) and specific binding of the second ligand (L2) to the third ligand (L3);

iv) Assaying the biological substance (O) by assaying the marker (M) contained in the immobilized conjugate (N1-N2-L1-O-L2-L3-M).

The second analytical method of the invention, when it uses the second analytical kit described above (namely the kit comprising the reagent A, reagent B′, reagent C and analytical device), comprises introducing the liquid sample, reagent A, reagent B′ and C individually into the analytical device. Thus, the second analytical method of the invention which uses the second analytical device comprises the following elements i) to iv):

i) Using the second analytical kit described above;

ii) Introducing the following materials a, b, c and d, individually without any admixing, into the passage in the analytical device contained in the analytical kit:
a. A liquid sample suspected of the occurrence therein of a biological substance (O) to be assayed,
b. A reagent A containing a conjugate (N2-L1) composed of a second nucleic acid (N2) having a base sequence at least complementary to the base sequence of the first nucleic acid (N1) immobilized in the capturing zone and a first ligand (L1) capable of specifically binding to the biological substance (O) to be assayed,
c. A reagent B′ containing a second ligand (L2) capable of specifically binding to the biological substance (O) to be assayed, and
d. A reagent C containing a conjugate (L3-M) composed of a third ligand (L3) capable of specifically binding to the second ligand (L2) and a marker (M);

iii) Allowing the formation of an immobilized conjugate (N1-N2-L1-O-L2-L3-M) by specific binding between the first nucleic acid (N1) immobilized in the capturing zone in the analytical device and the second nucleic acid (N2), specific binding between the first ligand (L1) and the biological substance (O), specific binding between the second ligand (L2) to the biological substance (O) and specific binding of the second ligand (L2) and the third ligand (L3);

iv) Assaying the biological substance (O) by assaying the marker (M) contained in the immobilized conjugate (N1-N2-L1-O-L2-L3-M).

When the biological substance (O) is an antigen, the state in the capturing zone after application of the first or second method of the invention using the first analytical kit or application of the first or second method of the invention using the second analytical kit is as shown in FIG. 9. In FIG. 9, the conjugate (N2-L1-O-L2-M) is found captured by the first nucleic acid (N1) immobilized in the capturing zone.

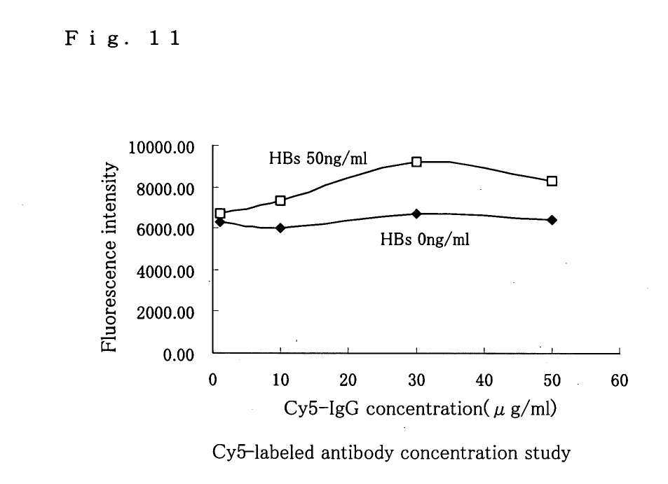

When the biological substance (O) is a nucleic acid (ON), the state in the capturing zone after application of the first or second method of the invention using the first analytical kit or application of the first or second method of the invention using the second analytical kit is as shown in FIG. 10. In FIG. 10, a first probe nucleic acid (PrN1) capable of specifically binding to the nucleic acid (ON) to be assayed is found in lieu of the ligand L1 in FIG. 9 and a second probe nucleic acid (PrN2) capable of specifically binding to the assay target nucleic acid (ON) further at another site thereof is found in lieu of the ligand L2 in FIG. 9. Thus, the first nucleic acid (N1) is immobilized on a solid phase (S), a first probe conjugate (N2-PrN1) resulting from binding between the second nucleic acid (N2) having a base sequence at least complementary to the base sequence of the first nucleic acid and the first probe nucleic acid (PrN1) capable of specifically binding to the nucleic acid (ON) to be assayed is bound there by specific binding between the first nucleic acid (N1) and the second nucleic acid (N2), the nucleic acid (ON) to be assayed is bound to the probe nucleic acid conjugate (N2-PrN1) by specific binding between the first probe nucleic acid (PrN1) and the nucleic acid (ON) and, further, a second probe conjugate (PrN2-M) composed of the second probe nucleic acid (PrN2) capable of specifically binding to the nucleic acid (ON) to be assayed and a marker (M) is bound thereto by specific binding between the second probe nucleic acid (PrN2) and the nucleic acid (ON) to be assayed.

The first analytical method of the invention which uses the third analytical kit described above (namely the kit containing no marker) is an analytical method targeting at a biological substance carrying a marker introduced therein and thus comprises introducing a mixture of a liquid sample and the reagent A prepared in advance into the analytical device. Thus, the first analytical method of the invention which uses the third analytical kit comprises the following elements i) to v):

i) Using the third analytical kit described above;

ii) Preparing a marker-carrying biological substance (O-M) in advance from a liquid sample suspected of the occurrence therein of a biological substance (O) to be assayed by introduction of a marker (M) into that substance;

iii) Introducing a reagent A containing a conjugate (N2-L1) composed of a second nucleic acid (N2) having a base sequence at least complementary to the base sequence of the first nucleic acid (N1) immobilized in the capturing zone and a first ligand (L1) capable of specifically binding to the biological substance (O) to be assayed and the marker-carrying biological substance (O-M), either after preliminary mixing up for conjugate formation or while allowing conjugate formation, into the passage in the analytical device contained in the analytical kit;

iv) Allowing the formation of an immobilized conjugate (N1-N2-L1-O-M) by specific binding between the first nucleic acid (N1) immobilized in the capturing zone in the analytical device and the second nucleic acid (N2);

v) Assaying the biological substance (O) by assaying the marker (M) contained in the immobilized conjugate (N1-N2-L1-O-M).

The second analytical method of the invention, when it uses the third analytical kit described above (namely the kit containing no marker) is an analytical method targeting at a biological substance carrying a marker introduced therein in which method the liquid sample and reagent A are introduced individually without preliminary mixing up. Thus, the second analytical method of the invention which uses the third analytical kit comprises the following elements i) to v):

i) Using the third analytical kit described above;

ii) Preparing a marker-carrying biological substance (O-M) in advance from a liquid sample suspected of the occurrence therein of a biological substance (O) to be assayed by introduction of a marker (M) into that substance;

iii) Introducing a reagent A containing a conjugate (N2-L1) composed of a second nucleic acid (N2) having a base sequence at least complementary to the base sequence of the first nucleic acid (N1) immobilized in the capturing zone and a first ligand (L1) capable of specifically binding to the biological substance (O) to be assayed and the marker-carrying biological substance (O-M) individually, without mixing together, into the passage in the analytical device contained in the analytical kit;

iv) Allowing the formation of an immobilized conjugate (N1-N2-L1-O-M) by specific binding between the first nucleic acid (N1) immobilized in the capturing zone in the analytical device and the second nucleic acid (N2);

v) Assaying the biological substance (O) by assaying the marker (M) contained in the immobilized conjugate (N1-N2-L1-O-M).

In the practice of the invention, the marker-carrying biological substance can be prepared by various methods known in the art. For example, poly (A) ⁺RNA is purified from a sample, and the RNA is amplified in the presence of oligo (dT)¹²⁻¹⁸ primers, dNTPs and dUTP labeled with Cy5 or Cy3, which is a fluorescent dye, under the action of T7 RNA polymerase; the thus-amplified RNA can be used as the biological substance. Alternatively, this is subjected, as the template, to the reverse transcriptase reaction; the thus-prepared Cy5- or Cy3-labeled DNA can also be used as the biological substance.

Therefore, the marker-carrying biological substance so referred to herein includes not only the products of introduction of a marker (M) into a biological substance (O) but also the product of introduction of a marker (M) into a biological substance (O) of another kind as synthesized based on the biological substance (O) to be assayed, for example DNA synthesized from RNA using a reverse transcriptase.

The first analytical method, when it uses the fourth analytical kit of the invention (namely the kit in which part of reagents, namely a ligand capable of specifically binding to a biological substance, is immobilized in the analytical device), is an analytical method according to which a liquid sample and a reagent are introduced, after preliminary mixing up, into the analytical device. Thus, the first analytical method of the invention which uses the fourth analytical kit comprises the following elements i) to iv):

i) Using the fourth analytical kit described above;

ii) Introducing the materials a and b given below, either after preliminary mixing up for conjugate formation or while allowing conjugate formation, into the passage in the analytical device contained in the analytical kit:
a. A liquid sample suspected of the occurrence of a biological substance (O) to be assayed,
b. A reagent containing a conjugate (L2-M) resulting from direct binding between a second ligand (L2) capable of specifically binding to the biological substance (O) to be assayed and a marker (M):

iii) Allowing the formation of an immobilized conjugate (N1-N2-L1-O-L2-M) by specific binding between the first ligand (L1) in the conjugate (N1-N2-L1) immobilized in the capturing zone in the analytical device and the biological substance (O) and by specific binding between the second ligand (L2) in the conjugate (L2-M) and the biological substance (O);

iv) Assaying the biological substance (O) by assaying the marker (M) contained in the immobilized conjugate (N1-N2-L1-O-L2-M).

The second analytical method of the invention, when it uses the fourth analytical kit described above (namely the kit in which part of reagents, namely a ligand capable of specifically binding to a biological substance, is immobilized in the analytical device), is an analytical method according to which a liquid sample and a reagent are introduced individually into the analytical device. Thus, the second analytical method of the invention in which the fourth analytical kit is used comprises the following elements i) to iv):

i) Using the fourth analytical kit described above;

ii) Introducing the following materials a and b individually, without mixing together, into the passage in the analytical device contained in the analytical kit:
a. A liquid sample suspected of the occurrence therein of a biological substance (O) to be assayed,
b. A reagent containing a conjugate (L2-M) resulting from direct binding between a second ligand (L2) capable of specifically binding to the biological substance (O) to be assayed and a marker (M);

iii) Allowing the formation of an immobilized conjugate (N1-N2-L1-O-L2-M) by specific binding between the first ligand (L1) in the conjugate (N1-N2-L1) immobilized in the capturing zone in the analytical device and the biological substance (O) and by specific binding between the second ligand (L2) in the conjugate (L2-M) and the biological substance (O);

iv) Assaying the biological substance (O) by assaying the marker (M) contained in the immobilized conjugate (N1-N2-L1-O-L2-M).

The first analytical method of the invention, when it uses the fifth analytical kit described above (namely the analytical kit in which part of reagents, namely a ligand capable of specifically binding to a biological substance, is immobilized in the analytical device and a second ligand (reagent B′) and a third ligand-marker (reagent C) are used in lieu of the second-ligand-marker (reagent B) in the fourth kit), comprises introducing a mixture of two or more of the liquid sample, reagent B′ and reagent C as prepared in advance into the analytical device, followed by introduction of the remaining material, if any, into the analytical device. Thus, the first analytical method of the invention which uses the fifth analytical kit described above comprises the following elements i) to iv):

i) Using the fifth analytical kit described above;

ii) Introducing two or more of the materials a, b and c given below, either after preliminary mixing for conjugate formation or while allowing conjugate formation, into the passage in the analytical device contained in the analytical kit, followed by introduction of the remaining material, if any, into the passage:
a. A liquid sample suspected of the occurrence therein of a biological substance (O) to be assayed,
b. A reagent B′ containing a second ligand (L2) capable of specifically binding to the biological substance (O) to be assayed,
c. A reagent C containing a conjugate (L3-M) composed of a third ligand (L3) capable of specifically binding to the second ligand (L2) and a marker (M);

iii) Allowing the formation of an immobilized conjugate (N1-N2-L1-O-L2-L3-M) by specific binding between the first ligand (L1) in the conjugate (N1-N2-L1) immobilized in the capturing zone in the analytical device and the biological substance (O), specific binding between the second ligand (L2) and the biological substance (O) and specific binding between the second ligand and the third ligand;

iv) Assaying the biological substance (O) by assaying the marker (M) contained in the immobilized conjugate (N1-N2-L1-O-L2-L3-M).

The second analytical method of the invention, when it uses the fifth analytical kit described above (namely part of reagents, namely a ligand capable of specifically binding to a biological substance, is immobilized in the analytical device and a second ligand (reagent B′) and a third ligand-marker (reagent C) are used in lieu of the second ligand-marker (reagent B) in the fourth kit), comprises introducing the liquid sample, reagent B′ and reagent C individually, without mixing together two or more of them, into the analytical device. Thus, the second analytical method of the invention which uses the fifth analytical kit described above comprises the following elements i) to iv):

i) Using the fifth analytical kit described above;

ii) Introducing the following materials a, b and c individually, without mixing together, into the passage in the analytical device contained in the analytical kit:
a. A liquid sample suspected of the occurrence therein of a biological substance (O) to be assayed,
b. A reagent B′ containing a second ligand (L2) capable of specifically binding to the biological substance (O) to be assayed,
c. A reagent C containing a conjugate (L3-M) composed of a third ligand (L3) capable of specifically binding to the second ligand (L2) and a marker (M);

iii) Allowing the formation of an immobilized conjugate (N1-N2-L1-O-L2-L3-M) by specific binding between the first ligand (L1) in the conjugate (N1-N2-L1) immobilized in the capturing zone in the analytical device and the biological substance (O), specific binding between the second ligand (L2) and the biological substance (O) and specific binding between the second ligand and the third ligand;

iv) Assaying the biological substance (O) by assaying the marker (M) contained in the immobilized conjugate (N1-N2-L1-O-L2-L3-M).

The first analytical method of the invention, when it uses the sixth analytical kit described above (namely the kit for assaying one or more biological substance species which comprises the reagent A, reagent B and analytical device), is an analytical method according to which a mixture of two or more of the liquid sample, reagent A and reagent B as prepared in advance is introduced into the analytical device, followed by introduction of the remaining material, if any, into the analytical device. Thus, the first analytical method of the invention which uses the sixth analytical device comprises the following elements i) to iv):

i) Using the sixth analytical kit described above;

ii) Introducing two or more of the materials a, b and c specified below, either after mixing together for conjugate formation or while allowing conjugate formation, into the passage in the analytical device contained in the analytical kit, followed by further introduction of the remaining material, if any, into the passage:
a. A liquid sample suspected of the occurrence therein of one or more biological substance species (Ok: k being an integer) to be assayed,
b. A reagent A solution containing conjugate species (N2h-L1i: h and i each independently being an integer) each composed of one of a plurality of second nucleic acid species (N2h: h being an integer) which has a base sequence at least complementary to the corresponding species among a plurality of first nucleic acid species (N1g: g being an integer) immobilized each independently, from species to species, in the capturing zone, and one of a plurality of first ligand species (L1i: i being an integer) which is capable of specifically binding to the corresponding species among the one or more biological substance species to be assayed;
c. A reagent B containing conjugate species (L2j-M1: j and 1 each independently being an integer) each composed of one of one or more second ligand species (L2j: j being an integer), which is capable of specifically binding to the corresponding species among the biological substance species (Ok: k being an integer), and one of one or more marker species (M1: 1 being an integer);

iii) Allowing the formation of conjugate species (N1g-N2h-L1i-Ok-L2j-M1: g, h, i, j, k and 1 each independently being an integer) immobilized each independently, from species to species, by specific binding between the plurality of first nucleic acid species (N1g: g being an integer) immobilized independently, from species to species, in the capturing zone in the analytical device and the plurality of second nucleic acid species (N2h: h being an integer), specific binding between the plurality of first ligand species (L1i: i being an integer) and the one or more biological substance species (Ok: k being an integer) and specific binding between the one or more second ligand species (L2j: j being an integer) and the one or more biological substance species (Ok: k being an integer);

iv) assaying the one or more biological substance species (Ok: k being an integer) by assaying the one or more marker species (M1: 1 being an integer) contained in the plurality of immobilized conjugate species (N1g-N2h-L1i-Ok-L2j-M1: g, h, i, j, k and 1 each independently being an integer) obtained in the above step.

The second analytical method of the invention, when it uses the sixth analytical kit (namely the kit for assaying one or more biological substance species which comprises the reagent A, reagent B and analytical device), is an analytical method according to which the liquid sample, reagent A and reagent B are introduced individually, without mixing together, into the analytical device. Thus, the second analytical method of the invention which uses the sixth analytical kit described above comprises the following elements i) to iv):

i) Using the sixth analytical kit described above;

ii) Introducing the following materials a, b and c individually, without mixing together, into the passage in the analytical device contained in the analytical kit:
a. A liquid sample suspected of the occurrence therein of one or more biological substance species (Ok: k being an integer) to be assayed,
b. A reagent A solution containing conjugate species (N2h-L1i: h and i each independently being an integer) each composed of one of a plurality of second nucleic acid species (N2h: h being an integer), which has a base sequence at least complementary to the corresponding species among the plurality of first nucleic acid species (N1g: g being an integer) immobilized each independently, from species to species, in the capturing zone and one of a plurality of first ligand species (L1i: i being an integer), which is capable of specifically binding to the corresponding species among the one or more biological substance species to be assayed;
c. A reagent B containing conjugate species (L2j-M1: j and 1 each independently being an integer) each composed of one of one or more second ligand species (L2j: j being an integer), which is capable of specifically binding to the corresponding species among the biological substance species (Ok: k being an integer) and one of one or more marker species (M1: 1 being an integer);

iii) Allowing the formation of conjugate species (N1g-N2h-L1i-Ok-L2j-M1: g, h, i, j, k and 1 each independently being an integer) immobilized independently, from species to species, by specific binding between the plurality of first nucleic acid species (N1g: g being an integer) immobilized each independently, from species to species, in the capturing zone in the analytical device and the plurality of second nucleic acid species (N2h: h being an integer), specific binding between the plurality of first ligand species (L1i: i being an integer) and the one or more biological substance species (Ok: k being an integer) and specific binding between the one or more second ligand species (L2j: j being an integer) and the one or more biological substance species (Ok: k being an integer);

iv) assaying the one or more biological substance species (Ok: k being an integer) by assaying the one or more marker species (M1: 1 being an integer) contained in the plurality of immobilized conjugate species (N1g-N2h-L1i-Ok-L2j-M1: g, h, i, j, k and 1 each independently being an integer) obtained in the above step.

The first analytical method of the invention, when it uses the seventh analytical kit (namely the kit for assaying one or more biological substance species which comprises the reagent A, reagent B′, reagent C and analytical device), is an analytical method according to which a mixture of the liquid sample, reagent A, reagent B′ and reagent C, mixed together in advance, are introduced into the analytical device, followed by the remaining material, if any, into the analytical device. Thus, the first analytical method of the invention which uses the seventh analytical kit comprises the following elements i) to iv):

i) Using the seventh analytical kit described above;

ii) Introducing a mixture of two or more of the materials a, b, c and d given below as prepared in advance into the passage in the analytical device contained in the analytical kit, followed by introduction of the remaining material (s), if any, into the passage:
a. A liquid sample suspected of the occurrence therein of one or more biological substance species (Ok: k being an integer) to be assayed,
b. A reagent A solution containing conjugate species (N2h-L1i: h and i each independently being an integer) each composed of one of a plurality of second nucleic acid species (N2h: h being an integer), which has a base sequence at least complementary to the corresponding species among the plurality of first nucleic acid species (N1g: g being an integer) immobilized each independently, from species to species, in the capturing zone, and one of a plurality of first ligand species (L1i: i being an integer) capable of specifically binding to the corresponding species among the one or more biological substance species to be assayed,
c. A reagent B′ containing one or more second ligand species (L2j: j being an integer) each capable of specifically binding to the corresponding one among the one or more biological substance species (Ok: k being an integer) to be assayed, and d. A reagent C containing conjugate species (L3m-M1: m and 1 each independently being an integer) each composed of one of one or more third ligand species (L3m: m being an integer), which is capable of specifically binding to the corresponding species among the second ligand species (L2j: j being an integer), and one of one or more marker species (M1: 1 being an integer);

iii) Allowing the formation of conjugate species (N1g-N2h-L1i-Ok-L2j-L3m-M1: g, h, i, j, k, 1 and m each independently being an integer) immobilized each independently, from species to species, by specific binding between the plurality of first nucleic acid species (N1g: g being an integer) immobilized independently, from species to species, in the capturing zone in the analytical device and the plurality of second nucleic acid species (N2h: h being an integer), specific binding between the plurality of first ligand species (L1i: i being an integer) and the one or more biological substance species (Ok: k being an integer), specific binding between the one or more second ligand species (L2j: j being an integer) and the one or more biological substance species (Ok: k being an integer) and specific binding between the one or more second ligand species (L2j: j being an integer) and the one or more third ligand species (L3m: m being an integer);

iv) assaying the one or more biological substance species (Ok: k being an integer) by assaying the one or more marker species (M1: 1 being an integer) contained in the plurality of immobilized conjugate species (N1g-N2h-L1i-Ok-L2j-L3m-M1: g, h, i, j, k, 1 and m each independently being an integer).

The second analytical method of the invention, when it uses the seventh analytical kit described above (namely the kit for assaying one or more biological substance species which comprises the reagent A, reagent B′, reagent C and analytical device), is an analytical method according to which the liquid sample, reagent A, reagent B′ and reagent C are introduced individually, without mixing together, into the analytical device. Thus, the second analytical method of the invention which uses the seventh analytical kit described above comprises the following elements i) to iv):

i) Using the seventh analytical kit described above;

ii) Introducing the following materials a, b, c and d individually, without mixing together, into the passage in the analytical device contained in the analytical kit:
a. A liquid sample suspected of the occurrence therein of one or more biological substance species (Ok: k being an integer) to be assayed,
b. A reagent A solution containing conjugate species (N2h-L1i: h and i each independently being an integer) each composed of one of a plurality of second nucleic acid species (N2h: h being an integer) having an at least complementary base sequence corresponding to the corresponding species among a plurality of first nucleic acid species (N1g: g being an integer) immobilized each independently, from species to species, in the capturing zone and one of a plurality of first ligand species (L1i: i being an integer), which is capable of specifically binding to the corresponding species among the one or more biological substance species to be assayed,
c. A reagent B′ containing one or more second ligand species (L2j: j being an integer) each capable of specifically binding to the corresponding one among the one or more biological substance species (Ok: k being an integer) to be assayed, and
d. A reagent C containing conjugate species (L3m-M1: m and 1 each independently being an integer) each composed of one of one or more third ligand species (L3m: m being an integer), which is capable of specifically binding to the corresponding species among the second ligand species (L2j: j being an integer), and one of one or more marker species (M1: 1 being an integer);

iii) Allowing the formation of conjugate species (N1g-N2h-L1i-Ok-L2j -L3m-M1: g, h, i, j, k, 1 and m each independently being an integer) immobilized independently, from species to species, by specific binding between the plurality of first nucleic acid species (N1g: g being an integer) immobilized each independently, from species to species, in the capturing zone in the analytical device and the plurality of second nucleic acid species (N2h: h being an integer), specific binding between the plurality of first ligand species (L1i: i being an integer) and the one or more biological substance species (Ok: k being an integer), specific binding between the one or more second ligand species (L2j: j being an integer) and the one or more biological substance species (Ok: k being an integer) and specific binding between the one or more second ligand species (L2j: j being an integer) and the one or more third ligand species (L3m: m being an integer);

iv) assaying the one or more biological substance species (Ok: k being an integer) by assaying the one or more marker species (M1: 1 being an integer) contained in the plurality of immobilized conjugate species (N1g-N2h-L1i-Ok-L2j-L3m-M1: g, h, i, j, k, 1 and m each independently being an integer).

The first analytical method of the invention, when it uses the eighth kit described above (namely the analytical kit for assaying one or more biological substance species each carrying a marker incorporated therein), is an analytical method according to which the liquid sample and reagent A are mixed together in advance and then introduced into the analytical device. Thus, the first method of the present invention which uses the eighth analytical kit comprises the following elements i) to v):

i) Using the eighth analytical kit described above;

ii) Preparing in advance one or more marker-carrying biological substance species (Ok-M1: k and 1 each independently being an integer) from a liquid sample suspected of the occurrence therein of one or more biological substance species (Ok: k being an integer) by introduction of one or more marker species (M1: 1 being an integer) into those biological substance species;

iii) Introducing a reagent A containing conjugate species (N2h-L1i: h and i each independently being an integer) each composed of one of a plurality of second nucleic acid species (N2h: h being an integer) which has a base sequence at least complementary to the corresponding species among the plurality of first nucleic acid species (N1g: g being an integer) immobilized each independently, from species to species, in a capturing zone and one of a plurality of first ligand species (L1i: i being an integer) capable of specifically binding to the one or more biological substance species (Ok: k being an integer) and the one or more marker-carrying biological substance species, either after mixing together for conjugate formation or while allowing conjugate formation, into the passage in the analytical device contained in the analytical kit;

iv) Allowing the formation of conjugate species (N1g-N2h-L1i-Ok-M1: g, h, i, k and 1 each independently being an integer) immobilized each independently by specific binding between the plurality of first nucleic acid species (N1g: g being an integer) immobilized each independently, from species to species, in the capturing zone and the plurality of second nucleic acid species (N2h: h being an integer) and specific binding between the plurality of first ligand species (L1i: i being an integer) and the one or more biological substance species (Ok: k being an integer);

v) Assaying the one or more biological substance species (Ok: k being an integer) by assaying the one or more marker species (M1: 1 being an integer) contained in the plurality of immobilized conjugate species (N1g-N2h-L1i-Ok-M1: g, h, i, j, k and 1 each independently being an integer).

The second analytical method of the invention, when it uses the eighth kit described above (namely the kit for assaying one or more biological substance species each carrying a marker incorporated therein), is an analytical method according to which the liquid sample and reagent A are introduced individually, without mixing together, into the analytical device. Thus, the second analytical method of the invention which uses the eighth analytical kit described above comprises the following elements i) to v):

i) Using the eighth kit described above;

ii) Preparing in advance one or more marker-carrying biological substance species (Ok-M1: k and 1 each independently being an integer) from a liquid sample suspected of the occurrence therein of one or more biological substance species (Ok: k being an integer) by introduction of one or more marker species (M1: 1 being an integer) into those biological substance species;

iii) Introducing a reagent A containing conjugate species (N2h-L1i: h and i each independently being an integer) each composed of one of a plurality of second nucleic acid species (N2h: h being an integer), which has a base sequence at least complementary to the corresponding one of a plurality of first nucleic acid species (N1g: g being an integer) immobilized each independently, from species to species, in a capturing zone and one of a plurality of first ligand species (L1i: i being an integer) capable of specifically binding to the one or more biological substance species (Ok: k being an integer) and the one or more marker-carrying biological substance species, individually without mixing together, into the passage in the analytical device contained in the analytical kit;

iv) Allowing the formation of conjugate species (N1g-N2h-L1i-Ok-M1: g, h, i, k and 1 each independently being an integer), each immobilized independently, by specific binding between the plurality of first nucleic acid species (N1g: g being an integer) immobilized each independently, from species to species, in the capturing zone and the plurality of second nucleic acid species (N2h: h being an integer) and specific binding between the plurality of first ligand species (L1i: i being an integer) and the one or more biological substance species (Ok: k being an integer);

v) Assaying the one or more biological substance species (Ok: k being an integer) by assaying the one or more marker species (M1: 1 being an integer) contained in the plurality of immobilized conjugate species (N1g-N2h-L1i-Ok-M1: g, h, i, j, k and 1 each independently being an integer).

The first analytical method of the invention, when it uses the ninth kit described above (namely the analytical kit for assaying one or more biological substance species in which kit ligands capable of specifically binding to the biological substance species are immobilized in the analytical device), is an analytical method according to which a mixture of the liquid sample and reagent as prepared in advance is introduced into the analytical device. Thus, the first analytical method of the invention which uses the ninth analytical kit described above comprises the following elements i) to iv):

i) Using the ninth analytical kit described above;

ii) Introducing the materials a and b specified below, either after mixing together for conjugate formation or while allowing conjugate formation, into the passage in the analytical device contained in the analytical kit:
a. A liquid sample suspected of the occurrence therein of one or more biological substance species (Ok: k being an integer),
b. A reagent containing conjugate species (L2j -M1: j and 1 each independently being an integer) resulting from direct binding between one or more second ligand species (L2j: j being an integer) capable of specifically binding to the corresponding species among the one or more biological substance species (Ok: k being an integer) and one or more marker species (M1: 1 being an integer);

iii) Allowing the formation of conjugate species (N1g-N2h-L1i-Ok-L2j-M1: g, h, i, j, k and 1 each independently being an integer), immobilized each independently, from species to species by specific binding between the plurality of first ligand species (L1i: i being an integer) in the conjugate species (N1g-N2h-L1i: g, h and i each independently being an integer) immobilized each independently, from species to species, in the capturing zone in the analytical device and the one or more biological substance species (Ok: k being an integer) and specific binding between the one or more second ligand species (L2j: j being an integer) in the conjugate species (L2j-M1: j and 1 each independently being an integer) in the reagent and the one or more biological substance species (Ok: k being an integer);

iv) Assaying the one or more biological substance species (Ok: k being an integer) by assaying the one or more marker species (M1: 1 being an integer) contained in the plurality of immobilized conjugate species (N1g-N2h-L1i-Ok-L2j-M1: g, h, i, j, k and 1 each independently being an integer).

The second analytical method of the invention, when it uses the ninth kit described above (namely the analytical kit for assaying one or more biological substance species in which kit ligands each capable of specifically binding to a biological substance species are immobilized in the analytical device), is an analytical method according to which the liquid sample and reagent are introduced individually, without mixing together, into the analytical device. Thus, the second analytical method of the invention which uses the ninth analytical kit described above comprises the following elements i) to iv):

i) Using the ninth analytical kit described above;

ii) Introducing the following materials a and b individually, without mixing together, into the passage in the analytical device contained in the analytical kit:
a. A liquid sample suspected of the occurrence therein of one or more biological substance species (Ok: k being an integer),
b. A reagent containing conjugate species (L2j-M1: j and 1 each independently being an integer) resulting from binding between one or more second ligand species (L2j: j being an integer) capable of specifically binding to the corresponding species among the one or more biological substance species (Ok: k being an integer) and one or more marker species (M1: 1 being an integer);

iii) Allowing the formation of conjugate species (N1g-N2h-L1i-Ok-L2j-M1: g, h, i, j, k and 1 each independently being an integer), immobilized each independently, by specific binding between the plurality of first ligand species (L1i: i being an integer) in the conjugate species (N1g-N2h-L1i: g, h and i each independently being an integer) immobilized each independently, from species to species, in the capturing zone in the analytical device and the one or more biological substance species (Ok: k being an integer) and specific binding between the one or more second ligand species (L2j: j being an integer) in the conjugate species (L2j-M1: j and 1 each independently being an integer) in the reagent and the one or more biological substance species (Ok: k being an integer);

iv) Assaying the one or more biological substance species (Ok: k being an integer) by assaying the one or more marker species (M1: 1 being an integer) contained in the plurality of immobilized conjugate species (N1g-N2h-L1i-Ok-L2j-M1: g, h, i, j, k and 1 each independently being an integer).

The first analytical method of the invention, when it uses the tenth analytical kit described above (namely the kit for assaying one or more biological substance species in which kit part of reagents, namely ligand species each capable of specifically binding to a biological substance species are immobilized in the analytical device), is an analytical method according to which a mixture of two or more of the liquid sample, reagent B′ and reagent C as prepared in advance is introduced into the analytical device, followed by introduction of the remaining material, if any, into the analytical device. Thus, the first analytical method of the invention which uses the tenth analytical kit comprises the following elements i) to iv):

i) Using the tenth analytical kit described above;

ii) Introducing two or more of the materials a, b and c specified below, either after mixing together in advance for conjugate formation or while allowing conjugate formation, into the passage in the analytical device contained in the analytical kit, followed by introduction of the remaining material, if any, into the passage:
a. A liquid sample suspected of the occurrence therein of one or more biological substance species (Ok: k being an integer) to be assayed,
b. A reagent B′ containing one or more second ligand species (L2j: j being an integer) each capable of specifically binding to the corresponding one among the one or more biological substance species (Ok: k being an integer) to be assayed,
c. A reagent C containing conjugate species (L3m-M1: m and 1 each independently being an integer) each composed of one of one or more third ligand species (L3m: m being an integer), which is capable of specifically binding to the corresponding species among the second ligand species (L2j: j being an integer) and one of one or more marker species (M1: 1 being an integer);

iii) Allowing the formation of immobilized conjugate species (N1g-N2h-L1i-Ok-L2j-L3m-M1: g, h, i, j, k, 1 and m each independently being an integer) by specific binding between the first ligand species (L1i: i being an integer) in the conjugate species (N1g-N2h-M1i: g, h and i each independently being an integer) immobilized each independently, from species to species, in the capturing zone in the analytical device and the biological substance species (Ok: k being an integer), specific binding between the second ligand species (L2j: j being an integer) and the biological substance species (Ok: k being an integer) and specific binding between the second ligand species (L2j: j being an integer) and the third ligand species (L3m: m being an integer);

iv) Assaying the one or more biological substance species (Ok: k being an integer) by assaying the one or more marker species (M1: 1 being an integer) contained in the immobilized conjugate species (N1g-N2h-L1i-Ok-L2j-L3m-M1: g, h, i, j, k, 1 and m each independently being an integer).

The second analytical method of the invention, when it uses the tenth analytical kit described above (namely the kit for assaying one or more biological substance species in which kit part of reagents, namely ligand species each capable of specifically binding to a biological substance species are immobilized in the analytical device), is an analytical method according to which the liquid sample, reagent B′ and reagent C are introduced individually, without mixing together, into the analytical device. Thus, the second analytical method of the invention which uses the tenth analytical kit comprises the following elements i) to iv):

i) Using the tenth analytical kit described above;

ii) Introducing the following materials a, b and c individually, without mixing together, into the passage in the analytical device contained in the analytical kit:
a. A liquid sample suspected of the occurrence therein of one or more biological substance species (Ok: k being an integer) to be assayed,
b. A reagent B′ containing one or more second ligand species (L2j: j being an integer) each capable of specifically binding to the corresponding one among the one or more biological substance species (Ok: k being an integer) to be assayed,
c. A reagent C containing conjugate species (L3m-M1: m and 1 each independently being an integer) each composed of one of one or more third ligand species (L3m: m being an integer), which is capable of specifically binding to the corresponding species among the second ligand species (L2j: j being an integer) and one of one or more marker species (M1: 1 being an integer);

iii) Allowing the formation of immobilized conjugate species (N1g-N2h-L1i-Ok-L2j-L3m-M1: g, h, i, j, k, 1 and m each independently being an integer) by specific binding between the first ligand species (L1i: i being an integer) in the conjugate species (N1g-N2h-L1i: g, h and i each independently being an integer) immobilized each independently, from species to species, in the capturing zone in the analytical device and the biological substance species (Ok: k being an integer), specific binding between the second ligand species (L2j: j being an integer) and the biological substance species (Ok: k being an integer) and specific binding between the second ligand species (L2j: j being an integer) and the third ligand species (L3m: m being an integer);

iv) Assaying the one or more biological substance species (Ok: k being an integer) by assaying the one or more marker species (M1: 1 being an integer) contained in the immobilized conjugate species (N1g-N2h-L1i-Ok-L2j-L3m-M1: g, h, i, j, k, 1 and m each independently being an integer).

Analytical Device and Analytical Method to be Used in the Case of a Marker having Been Introduced into the Target of Analysis

An analytical device carrying a reagent immobilized therein can be used as a device for assaying a marker-carrying biological substance as the target of analysis in carrying out the assay according to the invention. The analytical device is an analytical device comprising a passage or channel allowing a liquid to flow through the same as formed by bonding together a first member having a groove, 1 μm to 5 mm width and 1 μm to 750 μm depth in cross-section, and a second member capable of covering the groove, a first nucleic acid (N1) having an arbitrary base sequence as immobilized in a capturing zone provided in the passage on the first member and/or second member and, further, a conjugate (N2-L1) composed of a first ligand (L1) capable of specifically binding to a biological substance (O) to be assayed and a second nucleic acid (N2) having a base sequence at least complementary to the immobilized first nucleic acid as immobilized in the capturing zone by specific binding between the first nucleic acid (N1) and second nucleic acid (N2).

The analytical method of the invention which uses the above-mentioned analytical device containing a reagent immobilized therein as the device for assaying a marker-carrying biological substance as the target of analysis comprises the following elements i) to v):

i) Preparing, as the device for assaying a marker-carrying biological substance as the target of analysis, the above-mentioned analytical device with a reagent immobilized therein;

ii) Preparing in advance a marker-carrying biological substance (O-M) from a liquid sample suspected of the occurrence therein of an assay target biological substance (O) by introduction of a marker (M) thereinto;

iii) Introducing the marker-carrying biological substance (O-M) into the passage in the analytical device;

iv) Allowing the formation of an immobilized conjugate (N1-N2-L1-O-M) by specific binding between the first ligand (L1) in the conjugate (L1-N2) composed of the first ligand (L1) and second nucleic acid (N2) as immobilized in the capturing zone in the analytical device and the biological substance (O) in the marker-carrying biological substance (O-M);

v) Assaying the biological substance (O) by assaying the marker (M) contained in the immobilized conjugate (N1-N2-L1-O-M).

The analytical device and analytical method for assaying one or more biological substance species using a device carrying a reagent immobilized therein as the device for assaying the biological substance species with a marker introduced therein are as follows.

Thus, the device for assaying one or more biological substance species is an analytical device having a passage allowing a liquid to flow through the same as formed by bonding together a first member having a groove, 1 μm to 5 mm width and 1 μm to 750 μm depth in cross-section, and a second member capable of covering the groove, a plurality of first nucleic acid species (N1g: g being an integer) each having an arbitrary base sequence as immobilized each independently, from species to species, in a capturing zone provided in the passage on the first member and/or second member and, further, a plurality of conjugate species (L1i-N2h) each composed of one of a plurality of first ligand species (L1i: i being an integer) capable of specifically binding to the corresponding species among one or more biological substance species (Ok: k being an integer) to be assayed and one of a plurality of second nucleic acid species (N2h: h being an integer), which has a base sequence at least complementary to the corresponding species among the plurality of immobilized first nucleic acid species (N1g: g being an integer), as immobilized independently, from species to species, in the capturing zone by specific binding between the first nucleic acid species (N1g: g being an integer) and second nucleic acid species (N2h: h being an integer).

The analytical method of the invention which uses the above-mentioned analytical device containing a reagent immobilized therein as the device for assaying one or more marker-carrying biological substance species as the targets of analysis comprises the following elements i) to v):

i) Preparing, as the device for assaying one or more marker-carrying biological substance species as the targets of analysis, the above-mentioned analytical device with a reagent immobilized therein;

ii) Preparing in advance one or more marker-carrying biological substance species (Ok-M1: k and 1 each independently being an integer) from a liquid sample suspected of the occurrence therein of one or more assay target biological substance species (Ok: k being an integer) by introduction of one or more marker species thereinto;

iii) Introducing the one or more marker-carrying biological substance species (Ok-M1: k and 1 each independently being an integer) into the passage in the analytical device;

iv) Allowing the formation of immobilized conjugate species (N1g-N2h-L1i-Ok-M1: g, h, i, k and 1 each independently being an integer) by specific binding between the plurality of first ligand species (L1i: i being an integer) immobilized each independently, from species to species, in the capturing zone in the analytical device and the one or more biological substance species (Ok: k being an integer) in one or more marker-carrying biological substance species (Ok-M1: k and 1 each independently being an integer);

v) Assaying the one or more biological substance species (Ok: k being an integer) by assaying the one or more marker species (M1: 1 being an integer) contained in the immobilized conjugate species (N1g-N2h-L1i-Ok-M1: g, h, i, k and 1 each independently being an integer).

The rate of flow through the passage in the analytical device used in any of the above-mentioned analytical methods of the invention is desirably 0.1 to 50 μL/minute from the microfluidic system construction viewpoint.

In carrying out any of the above-mentioned analytical methods of the invention, the sample and reagents are introduced into the passage in the analytical device, for example, by feeding the liquids under pressure using a syringe pump or peristaltic pump, or under suction using a syringe pump or peristaltic pump, or by allowing the solutes alone to flow in the manner of electroosmosis without allowing the solution itself to flow.

As the marker detection method in carrying out any of the above-mentioned analytical methods of the invention, there may be mentioned fluorescence measurement, photogenesis measurement, spectrophotometric measurement, thermal lens measurement, surface plasmon absorption measurement, electrochemical measurement and visual observation. The thermal lens measurement method is an analytical method described in JP-A No. 2000-356611 (Patent Document 10) and enables very high sensitivity detection. This measurement can be made using the thermal lens microscope ITML-10 or ITML-11 available from Institute of Microchemical Technology Co., Ltd. It is also possible to carry out the measurement using a miniaturized thermal lens microscope in which a SELFOC lens according to the technology of Yamaguchi et al. (Y. Baba et al. (eds.), Micro Total Analysis Systems 2002, Vol. 1, 281-283) is employed.

In any of the above-mentioned analytical methods of the invention, the target of analysis is as shown in the above description of the analytical kits.

By using a random access distribution system, it becomes possible to carry out assays for an arbitrary combination of items as selected from among an infinite number of combinations of assays. By applying such a random access distribution system as described in Japanese Translation of Unexamined PCT Appln. No. H09-503060 (WO 95/08774) (Patent Document 11) to the analytical device of the present invention, it becomes possible to carry out automatic measurements for an arbitrary combination of items as selected from among an infinite number of combinations of assays. For example, when 10 oligonucleotide species respectively having different sequences A, B . . . J are immobilized in one microchip and substances are prepared by binding 10 different immunological ligand species to oligonucleotide species respectively having a complementary sequence to A . . . J and binding thereto marker species corresponding to the respective immunological ligand species, it is possible to carry out one arbitrary combination of assays as selected from among 10¹⁰ combinations. Further, when substances resulting from binding of 100 different immunological ligand species to oligonucleotides respectively having a complementary sequence to A . . . J and further binding of marker species corresponding to the respective immunological ligand species are prepared, it is possible to carry out one combination of assays as selected from among 100¹⁰ combinations.

Analytical Device Manufacturing Method

The analytical device manufacturing method of the invention is characterized in that a nucleic acid for binding a ligand is immobilized at a place to become a passage between two sheet members before fusing the two sheet members together. The following method may be mentioned as the analytical device manufacturing method of the invention.

(1) Preparing a first member having a groove, 1 μm to 5 mm width and 1 μm to 750 μm depth, and a second member capable of covering the groove,

wherein the groove is a portion to become a passage upon joining the first member and second member together and one of the first member and second member or both have a passage inlet and passage outlet,

(2) Immobilizing a nucleic acid (N1) having an arbitrary base sequence at a site to become a zone for capturing a biological substance to be assayed in a portion to become a passage on the first member and/or second member,

(3) Then, joining the first member and second member together by thermal fusion or with an adhesive to give an assembly with a passage formed therein,

(4) Introducing a reagent A containing a conjugate (N2-L1) composed of a second nucleic acid (N2) having a base sequence at least complementary to the base sequence of the first nucleic acid (N1) immobilized in the capturing zone and a first ligand (L1) capable of specifically binding to a biological substance to be assayed into the passage in the assembly, and allowing the conjugate (N2-L1) to specifically bind, for immobilization thereof, to the first nucleic acid (N1) in the capturing zone to thereby obtain an analytical device.

In cases where a plurality of biological substance species should be assayed, the following analytical device manufacturing method is preferred.

(1) Preparing a first member having a groove, 1 μm to 5 mm width and 1 μm to 750 μm depth, and a second member capable of covering the groove,

wherein the groove is a portion to become a passage upon joining the first member and second member together and one of the first member and second member or both have a passage inlet and passage outlet,

(2) Immobilizing a plurality of nucleic acid species (N1g: g being an integer) each having an arbitrary base sequence, each independently, at a site to become a zone for capturing one or more biological substance species to be assayed within a portion to become a passage on the first member and/or second member,

(3) Then, joining the first member and second member together by thermal fusion or with an adhesive to give an assembly with a passage formed therein,

(4) Introducing a reagent A containing conjugate species (N2h-L1i: h and i each independently being an integer) each composed of one of a plurality of second nucleic acid species (N2h: h being an integer), which has a base sequence at least complementary to the base sequence of the corresponding species among the plurality of first nucleic acid species (N1g: g being an integer) immobilized in the capturing zone, and one of a plurality of first ligand species (L1i: i being an integer) capable of specifically binding to the corresponding species among one or more biological substance species to be assayed into the passage in the assembly, and allowing the plurality of conjugate species (N2h-L1i: h and i each independently being an integer) to specifically bind, for immobilization thereof, to the plurality of first nucleic acid species (N1g: g being an integer) in the capturing zone to thereby obtain an analytical device suited for use in assaying one or more biological substance species.

The material of the first member and second member to be used in analytical device manufacture in the practice of the invention may be selected from among glass, polydimethylsiloxane, ceramics, acrylonitrile-butadiene rubber-styrene resins, acrylonitrile-ethylene propylene rubber-styrene resins, acrylonitrile-styrene resins, methacrylic-styrene resins, polyamide nylon resins, polybutylene terephthalate resins, polycarbonate resins, polyethylene resins, polyethylene terephthalate polyester resins, polyimide resins, methacrylic resins, polyacetal resins, polypropylene resins, polyphenylene ether resins, polyphenylene sulfide resins, polystyrene resins, thermoplastic elastomer resins, alloys, liquid crystal polymer resins, cycloolefin resins, thermoplastic resins, epoxy resins, phenol resins, unsaturated polyester resins, diallyl phthalate resins, cyclic olefin copolymers and, further, members made of these materials and subjected to surface modification. The material of the first member and that of the second member may be the same or different.

In manufacturing the analytical devices of the invention, the temperature at which the first member and second member are fused together is preferably 70° C. to 140° C. This is because, at below 70° C., the fusion will be insufficient and, at above 140° C., the first nucleic acid directly immobilized on these members will be affected by the heat. Further, it is known that nucleic acids are more resistant to inactivation by solvents as compared with proteins (Molecular Cloning, second edition, Sambrook, Fritsch and Maniatis (authors), Cold Spring Harbor Laboratory Press, 1989, 9.14-9.19 (Non-Patent Document 6); Applied Biosystems DNA Synthesizer model 391 use manual “User Bulletin No. 50” (Non-Patent Document 7)).

The ligands to be used in the analytical kits, analytical devices, analytical methods and analytical device manufacturing methods described hereinabove are capable of specifically binding to a biological substance to be assayed. When the biological substance to be assayed is an antigen, for instance, the ligand is an antibody. When it is an antibody, the ligand is an antigen and, when it is a nucleic acid, the ligand is a probe nucleic acid (PrN).

### EFFECTS OF THE INVENTION

By using the analytical device manufacturing method of the invention, it becomes possible to produce microfluidic system-based analytical devices for assaying biological substances such as biopolymers in a simple production process with high reproducibility. When analytical kits comprising a combination of the analytical device of the invention and reagents are used, biopolymers can be assayed with high precision, which is useful in clinical diagnoses.

The following advantages 1 to 3 are obtained by causing a first ligand (L1) having a base sequence at least complementary to a first nucleic acid (N1) immobilized in the passage in the analytical device to be used in the practice of the invention to be immobilized in that passage by binding to that nucleic acid as compared with the case of such a first ligand (L1) being directly bound to a solid phase.

1. Generally, immunological ligands as ligands for capturing biological substances are most often proteins. Proteins are, however, unstable against heat and organic solvents, among others. For example, a temperature of 75-112° C. and a heating period of 5 minutes or longer are required as conditions for sealing of plastic materials (L. E. Locascio et al., J. Chromatogr. A, 857 (1999) 275-284) and proteins are very unstable at such a temperature. Thus, when immunological ligands are directly immobilized on plastics or the like and then sealing is performed, the possibility of such ligands being deactivated is very high. However, it is known that nucleic acids such as oligonucleotides are stable against heat and various organic solvents as compared with proteins, and it is easy to expect that even when sealing is carried out at a temperature exceeding 100° C., they will retain their ability to bind to complementary nucleic acids. In fact, it has been confirmed that the hybridization efficiency is not affected even upon 1 hour of heating at 110° C., as described later herein in the Examples section. Therefore, by using a chip manufactured in accordance with the invention and by causing a nucleic acid complementary to the immobilized nucleic acid to bind to an immunological ligand, causing the resulting complementary nucleic acid-immunological ligand conjugate to flow through the passage and thereby allowing the complementary nucleic acid-immunological ligand conjugate to bind to the nucleic acid bound to a solid phase, it becomes possible to produce, with ease, a chip having a microchannel with the immunological ligand bound thereto. This series of reactions may be carried out sequentially, reagent by reagent, or part or all of the reactions may be carried out simultaneously. For example, Cain et al. (Allergy (1998) 53, 1213-1215) subjected the mite-derived allergen species Derp1 and Derf1, among others, to heat treatment and ascertained the extents of their antigenicity. According to their experimental results, it is confirmable that Derp1, upon 30 minutes heating at 100° C., loses 85% of its initial antigenicity and Derf1 loses 98% of its initial antigenicity upon 30 minutes of heating at 100° C. When such an antigen, when applied to a plastic material for allergy testing and the material is subjected to the step of thermal fusion to a member having a groove, the antigenicity thereof will be lost and thus the possibility of failure in performing accurate assays is very high. On the contrary, the method according to the invention, which can avoid such heat-due antigen inactivation, makes it possible to perform assays in a condition such that there is no antigen inactivation.

Now, the case of joining the first member and second member together using an adhesive is discussed. In extracting nucleic acids, for instance, phenol extraction is generally performed. This is a procedure for extracting nucleic acids from a biological sample by denaturing and precipitating proteins with phenol and recovering nucleic acids remaining intact in an aqueous phase. Nucleic acids will not be denatured under these conditions, namely upon exposure to phenol. In addition, there are available purification procedures using, as an organic solvent, phenol/chloroform/isoamyl alcohol (25/24/1), chloroform/phenol (1/1) or isopropanol (Non-Patent Document 6); nucleic acids are not denatured under such conditions, either. Proteins are, however, known to be denatured under such conditions. Further, acetonitrile (100%), dichloromethane (86%) and tetrahydrofuran (84%) are used in synthesizing oligonucleotides (Non-Patent Document 7) and nucleic acids are never denatured in such solvents but proteins are often denatured therein.

In view of the above facts, when proteins are immobilized on a solid phase, the possibility of immobilized proteins being denatured upon exposure to an organic solvent contained in an adhesive is very high whereas, when nucleic acids are immobilized, the possibility of their binding capacity decreasing is much lower as compared with proteins.

2. Even if immunological ligands can be stably immobilized in microchannels, it is necessary in the art, when assay items are changed, to prepare chips with corresponding immunological ligands immobilized therein. Therefore, it is necessary in the art to experimentally determine the immobilization conditions appropriate for the physical properties of immunological ligands to be immobilized and carry out the immobilization procedure under such conditions. In the case of antibodies having relatively constant physical properties, this work is not difficult but, in the case of antigens much differing in physical properties, it is a very difficult work to immobilize them with good reproducibility. On the contrary, it is nucleic acids that are to be immobilized by the method of the invention. It is known that nucleic acids do not differ much in physical properties depending on differences in sequence as compared with immunological ligands whose physical properties differ much according to their amino acid sequences and that nucleic acids can generally be immobilized under almost the same conditions. Thus, the known methods of immobilizing such nucleic acids can be employed as such in the practice of the invention.

Further, in the art, even if conditions of stable immobilization can be found, it is necessary to prepare chips with immunological ligands or nucleic acids immobilized therein as different ligands in response to the biological substance species to be assayed and thus draw up a detailed production schedule. Otherwise, the manufacturer may possibly have dead stock. According to the method of the invention, however, nucleic acids having an arbitrary sequence having no connection with assay targets, whether they are immunologically active substances or nucleic acids, are subjected to immobilization, so that it is possible to consider the respective assay items and the chips to be used to be quite independent matters. For example, if there is a chip with a base sequence 1 immobilized in a microchannel thereof, the chip, when combined with a conjugate prepared by binding an anti-hepatitis B surface antigen antibody to a base sequence 1′ complementary to the base sequence 1, can be used for assaying the hepatitis B surface antigen and, when combined with a conjugate prepared by binding the type C hepatitis antigen to the base 1′, the chip can be used for detecting a hepatitis C antibody. Furthermore, when a sequence capable of binding to part of the sequence of a gene involved in adipocyte differentiation is bound to the base sequence 1′ and there is a labeled nucleic acid capable of binding to the gene involved in adipocyte differentiation, the chip previously intended for use in detecting or assaying immunological ligands can also be used as such for detecting the gene sequence involved in adipocyte differentiation. This means that if one chip carrying an immobilized nucleic acid and conjugates capable of binding to respective assay targets and containing a complementary nucleic acid capable of binding to the immobilized nucleic acid are available, all kinds of assay targets can be assayed with the one sort of immobilized nucleic acid-carrying chip. Thus, the chip production cost can be markedly reduced.

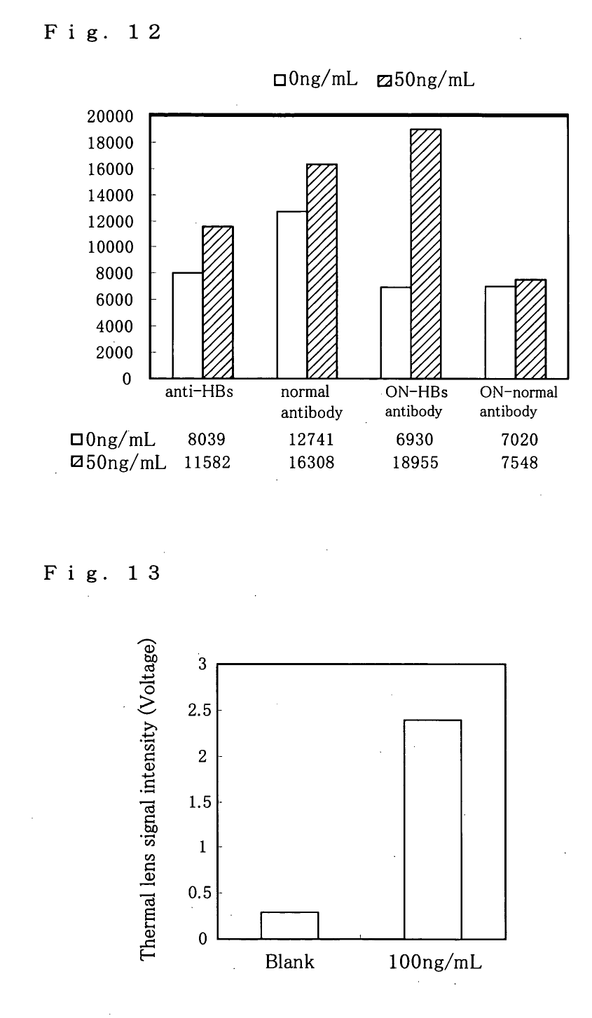

### BRIEF DESCRIPTION OF THE DRAWINGS

[FIG. 1] This figure is a schematic plan view illustrating an example of the analytical device to be used in the practice of the invention.

[FIG. 2] This figure is a section view of the device shown in FIG. 1.

[FIG. 3] This figure shows a mode of embodiment of the analytical device such that there is one passage inlet, the passage branches, on its way, into a plurality of subsidiary passages and there are a plurality of passage outlets.

[FIG. 4] This figure shows a mode of embodiment of the analytical device such that there are a plurality of passage inlets, the respective passages gather, on their way, into one passage and there is one passage outlet.

[FIG. 5] This figure shows a mode of embodiment of the analytical device such that there is one passage inlet, the passage branches, on its way, into a plurality of subsidiary passages, which further gather, on their way, into one passage and there is one passage outlet.

[FIG. 6] This figure shows a mode of embodiment of the analytical device for assaying one or more biological substance species as constituted such that there is one passage inlet and there is one passage outlet.

[FIG. 7] This figure is a schematic representation of the first analytical kit of the invention and shows, as an example, the case where the first ligand (L1) and second ligand (L2) are antibodies and the analytical device, first reagent and second reagent occur independently.

[FIG. 8] This figure is a schematic representation of the fourth analytical kit of the invention and shows, as an example, the case where the first ligand (L1) and second ligand (L2) are antibodies and the analytical device and reagent occur independently.

[FIG. 9] This figure shows the state in the capturing zone after application of the first or second analytical method using the first analytical kit or second analytical kit in the case of the biological substance (O) being an antigen.

[FIG. 10] This figure shows the conjugate bound in the capturing zone in the case of the biological substance to be assayed being a nucleic acid (ON).

[FIG. 11] This figure is a graphic representation of the assay results obtained in Example 1.

[FIG. 12] This figure is a graphic representation of the results of fluorescence intensity detection using a DNA micro array scanner (Biodetect 645 Reader: trademark, product of GeneScan) after reacting Chip A, Chip B, Chip C-1 and Chip C-2 with a sample containing or free of the HBs antigen.

[FIG. 13] This figure is a graphic representation of the results of an immunoassay using a plastic chip prepared by applying an oligonucleotide to a substrate, followed by thermal fusion.

### EXPLANATION OF SYMBOLS

1, 1A, 1B, 1C, 1D, 11, 14—analytical device
2—passage
3, 3-1, 3-2, 3-3, 3-4, 3-5, 3-6—passage inlet
4, 4-1, 4-2, 4-3, 4-4, 4-5, 4-6—passage outlet
5—first member
6—second member
7, 7-1, 7-2, 7-3, 7-4, 7-5, 7-6—capturing zone
12—reagent A
13, 15—reagent B

### EXAMPLE 1

(1) DNA Immobilization

An oligonucleotide A with an amino group introduced thereinto at the 5′ terminus having the sequence specified under SEQ ID NO:1, namely Amino group-CGA CGGATC CCC GGGAAT TC (SEQ ID NO:1) was synthesized and diluted to 8.45 μM with PBS(−) containing 1 mM EDTA. This solution was spotted (1 mm in diameter) on a slide glass (GeneSlide: trademark, product of Nihon Parkerizing Co., Ltd.). The slide glass was heated on a hot plate heated at 100° C. for 1 hour to thereby covalently immobilize the oligonucleotide A. Then, it was washed with 2×SSC/0.2% SDS for 15 minutes, then with 2×SSC/0.2% SDS at 90° C. for 5 minutes and further with sterilized water and dried. A slide glass with the oligonucleotide A immobilized thereon was thus prepared.

(2) Passage Construction and Reaction 1

A flat polydimethylsiloxane (hereinafter referred to as “PDMS”) sheet with a groove (width: 300 μm, height: 100 μm) formed thereon to serve as a microchannel was joined to the immobilized oligonucleotide-carrying slide glass prepared by immobilizing the oligonucleotide A in the above step (1) in the manner of contact bonding so that a passage or channel might be positioned on the oligonucleotide A immobilized on the slide glass to construct a chip. PBS containing 2% BSA and 1 mM EDTA was fed to and passed through the channel (width: 300 μm, height: 100 μm) formed inside the chip for 15 minutes and, then, an anti-HBs antibody bound to an oligonucleotide B complementary to the immobilized oligonucleotide A (as prepared by the method of Oku et al. (J. Immunol. Methods, Dec. 1, 2001:258(1-2):73-84) diluted to a concentration of 500 μg/mL with PBS containing 0.1% BSA and 1 mM EDTA (hereinafter, “0.1% PBS”) was fed to the channel for 15 minutes. Then, the channel was washed by feeding 0.1% PBS for 5 minutes, and the HBs antigen adjusted to 50 ng/mL with 0.1% PBS was fed to the channel for 15 minutes. Thereafter, the channel was washed by feeding 0.1% PBS for 5 minutes, and a Cy5-labeled anti-HBs antibody adjusted to a concentration of 1 μg/mL, 10 μg/mL, 30 μg/mL or 50 μg/mL with 0.1% PBS was fed to the channel for 15 minutes. All the reactions were carried out at 37° C. and at a flow rate of 1 μl/minute.

(3) Analysis

The glass slide portion was separated from the PDMS portion, and the slide glass portion was subjected to fluorescence intensity measurement using Biodetect 645/4 chip reader (trademark, product of GeneScan). The results are shown in Table 1 and FIG. 11. The unit is the signal intensity unit. From these results, 30 μg/mL was considered to be appropriate as the Cy5-labeled antibody concentration.

TABLE 1
Cy5-labeled antibody concentration study

| | | | Cy5-IgG concentration | | | |
|---|---|---|---|---|---|---|
| HBs concentration | | | 1 μg/ml | 10 μg/ml | 30 μg/ml | 50 μg/ml |
| | 0 | ng/ml | 6292.00 | 6038.33 | 6745.33 | 6407.67 |
| | 50 | ng/ml | 6744.50 | 7328.50 | 9209.75 | 8349.75 |

(4) Direct Antibody Immobilization

The same antibody as used as the oligonucleotide B-bound anti-HBs antibody in the above step (2) was diluted with PBS(−) to 1000 μg/mL. This solution was spotted (diameter: 1 mm) on a slide glass (GeneSlide: trademark, product of Nihon Parkerizing Co., Ltd.). Thereafter, the antibody was immobilized by heating on a hot plate heated at 110° C. for 1 hour, or at room temperature. Then, the slide glass was washed with PBS(−) for 5 minutes and sterilized water, and dried. An immobilized anti-HBs antibody-carrying slide glass was thus prepared.

(5) Microchannel Construction and Reaction 2

A chip was constructed by joining a polydimethylsiloxane sheet with a groove (width: 300 μm, depth: 100 μm) to become a microchannel as formed thereon to the immobilized anti-HBs antibody-carrying slide glass prepared in the above step (4) in the manner of contact bonding at room temperature. PBS containing 2% BSA and 1 mM EDTA was fed to and passed through the microchannel for 15 minutes. Then, the HBs antigen adjusted to 50 ng/mL with 0.1% PBS was fed to the channel for 15 minutes. Thereafter, the channel was washed by feeding 0.1% PBS for 5 minutes, and the Cy5-labeled antibody adjusted to 30 μg/mL with 0.1% PBS was fed to the channel for 15 minutes. All the reactions were carried out at 37° C. and at a flow rate of 1 μl/minute. Thereafter, the reactivity on the chip was confirmed using a chip reader in the same manner as in the above step (3). As a result, while the reaction was confirmed when the antibody was immobilized at room temperature, no reactivity could be confirmed in the case of immobilization at 110° C.

### Discussion of Example 1

The results obtained in the above step 5 and step 3 indicate the following. Thus, when a microfluidic chip is constructed by joining a member having a channel groove as prepared by injection molding and a film or flat sheet together by thermal fusion according to the conventional method of antibody immobilization, the possibility of antibody inactivation is very high and no chip suited for use in immunological detection can be prepared. On the contrary, when the method of the present invention is used, the nucleic acid shows its stable binding ability even after 1 hour of heating at 110° C. and therefore immunological detection is possible by constructing a microfluidic chip by joining together a member having a channel groove as prepared by injection molding and a film or flat sheet in the manner of thermal fusion, for instance, reacting an antibody bound to a DNA′ having a base sequence at least complementary to the DNA immobilized within the chip channel with that DNA to form a conjugate
(substrate-DNA)-(DNA′-antibody) and thereafter reacting an antigen with the conjugate, followed by binding a Cy5-labeled antibody to form a
(substrate-DNA)-(DNA′-antibody)-(antigen)-(Cy5-labeled antibody) conjugate.

### EXAMPLE 2

Three materials (a monoclonal antibody to HBs (hepatitis B surface antigen), mouse normal antibody to HBs, and the oligonucleotide A) were individually immobilized on separate slide glasses (GeneSlide: trademark, product of Nihon Parkerizing Co., Ltd.) by heating (immobilization treatment a, immobilization treatment b and immobilization treatment c) to give three immobilization treatment product substrates. A flat sheet member having a groove to become a microchannel as formed thereon was joined to each of the three immobilization product substrates obtained to give three different assemblies each having the immobilized material immobilized within the microchannel formed therein.

Then, in the case of the immobilization product substrate carrying the oligonucleotide immobilized therein, an anti-HBs antibody labeled with an oligonucleotide complementary to the oligonucleotide A or the mouse normal antibody labeled with the complementary oligonucleotide B was immobilized on the substrate by complementary binding between the oligonucleotides, and the immunological reaction was carried out. On the other hand, the immunological reaction was carried out in the same manner using the substrate obtained by directly immobilizing thereon the antibody (monoclonal antibody or mouse normal antibody to HBs, namely the hepatitis B surface antigen) Details of these treatments and the results are described below in detail.

(1) DNA or Antibody Immobilization

### (Immobilization Treatment a)

PBS containing 500 μg/mL of a mouse monoclonal anti-HBs antibody was spotted on GeneSlide (trademark, product of Nihon Parkerizing Co., Ltd.) using a micropipette and, after 1 hour of incubation at 37° C. for immobilization, the slide glass was washed with MilliQ water and then dried. Thereafter, the immobilization product substrate was heated at 130° C. for 20 minutes, whereby an immobilization product glass substrate A was obtained.

(Immobilization Treatment b)

PBS containing 500 μg/mL of a mouse normal antibody was spotted on GeneSlide (trademark, product of Nihon Parkerizing Co., Ltd.) using a micropipette and, after 1 hour of incubation at 37° C. for immobilization, the slide glass was washed with MilliQ water and then dried. Thereafter, the immobilization product substrate was heated at 130° C. for 20 minutes, whereby an immobilization product glass substrate B was obtained.

(Immobilization Treatment c)

PBS containing the same 5′-terminally aminated oligonucleotide A as the oligonucleotide used in Example 1 as specified under SEQ ID NO:1 at a concentration of 25 μM was applied onto GeneSlide (trademark, product of Nihon Parkerizing Co., Ltd.), followed by 1 hour of incubation at 80° C. for immobilization. After 5 minutes of blocking in a water bath at 95° C., the slide glass was washed with MilliQ water and then dried. Thereafter, the substrate was heated at 130° C. for 20 minutes to give an immobilization product glass substrate C.

(2) Chip Construction and Blocking

A flat polydimethylsiloxane (PDMS) sheet (product of Fluidware Technologies, straight type) with grooves (300 μm in width, 100 μm in depth) formed thereon to serve as microchannels was joined to each of the immobilization product glass substrates A, B and C prepared in the above step (1) in the manner of contact bonding utilizing the tackiness of PDMS to construct Chip A, Chip B and Chip C (A, B and C corresponding to the immobilization product glass substrates A, B and C, respectively) each having microchannels (300 μm in channel width, 100 μm in channel depth) formed between the immobilization product glass substrate and the flat sheet. The chips obtained each was rectangular in shape, 75 mm in total length and 25 mm in with, with one inlet and one outlet each having an opening diameter of 1 mm ø and positioned at a site 5 mm from each end. It has four channels, 300 μm in channel width and 100 μm in channel depth, disposed in parallel with one another at 7-mm intervals. Then, blocking was effected by feeding PBS containing 1% BSA and 1 mM EDTA to the channels formed within each chip.

Then, PBS containing 50 ρg/mL of an anti-HBs antibody labeled with an oligonuleotide, GAATTCCCGGGGATCCGTCG (oligonucleotide B shown under SEQ ID NO:2), 1% BSA and 1 mM EDTA was fed to and passed through the microchannels in the blocked Chip C obtained in the above step for 15 minutes. The microchannels were washed by feeding therethrough PBS containing 1% BSA and 1 mM EDTA for 3 minutes to give Chip C1. Separately, Chip C2 was obtained by feeding PBS containing 50 μg/mL of a mouse normal antibody labeled with GAATTCCCGGGGATCCGTCG (oligonucleotide B shown under SEQ ID NO:2), 1% BSA and 1 mM EDTA through the microchannels in another blocked chip C obtained in the above step, followed by 3 minutes of feeding of PBS containing 1% BSA and 1 mM EDTA for washing.

(3) Antigen Binding Capacity Study

(Confirmation of Antigen Binding Capacity of Chip A)

A Chip A species treated with PBS containing the HBs antigen was obtained by feeding PBS containing 50 ng/mL HBs antigen, 1% BSA and 1 mM EDTA to the microchannels of the blocked Chip A obtained in the above step (2) for 15 minutes, followed by washing by feeding PBS containing 1% BSA and 1 mM EDTA for 3 minutes.

Separately, another Chip A species treated with HBs antigen-free PBS was obtained in the same manner as in the step of obtained the above-mentioned HBs antigen-treated Chip A except that PBS containing no HBs antigen and containing 1% BSA and 1 mM EDTA was fed.

Then, PBS containing 30 μg/mL of a biotinylated anti-HBs antibody, 1% BSA and 1 mM EDTA was fed to each chip species obtained in the above step for 15 minutes, and the chip was then washed by feeding PBS containing 1% BSA and 1 mM EDTA for 3 minutes. Finally, PBS containing 10 μg/mL of Cy5-labeled streptavidin, 1% BSA and 1 mM EDTA was fed to each chip (Chip A treated with HBs antigen-containing PBS or Chip A treated with HBs antigen-free PBS) obtained in the above step for 15 minutes, followed by feeding PBS containing 1% BSA and 1 mM EDTA for 3 minutes for washing. Thereafter, the PDMS portion was peeled off, and the substrate was washed with MilliQ water and subjected to fluorescence intensity detection using a chip reader to confirm the antigen binding capacity. The results are graphically shown in FIG. 12, with the fluorescence intensity being taken as the ordinate.

(Confirmation of Antigen Binding Capacity of Chip B)

The antigen binding capacity was confirmed in the same manner as in the treatment for antigen binding capacity confirmation described above under “Confirmation of antigen binding capacity of Chip A” except that Chip B was used in lieu of Chip A. The results are graphically shown in FIG. 12, with the fluorescence intensity being taken as the ordinate.

(Confirmation of Antigen Binding Capacity of Chip C-1)

The antigen binding capacity was confirmed in the same manner as in the treatment for antigen binding capacity confirmation described above under “Confirmation of antigen binding capacity of Chip A” except that Chip C-1 was used in lieu of Chip A. The results are graphically shown in FIG. 12, with the fluorescence intensity being taken as the ordinate.

(Confirmation of Antigen Binding Capacity of Chip C-2)

The antigen binding capacity was confirmed in the same manner as in the treatment for antigen binding capacity confirmation described above under “Confirmation of antigen binding capacity of Chip A” except that Chip C-2 was used in lieu of Chip A. The results are graphically shown in FIG. 12, with the fluorescence intensity being taken as the ordinate.

(4) Results

According to the graph in FIG. 12, even when the mouse normal antibody incapable of reacting with the HBs antigen was immobilized on the substrate and subjected to heat treatment, a higher value was obtained in the case of feeding the HBs antigen into the channels than in the case of feeding the HBs antigen-free solution thereinto. Based on this result, the reaction occurring after direct immobilization of the anti-HBs antibody on the substrate followed by heat treatment can be estimated to be due to nonspecific binding. This is estimably the result of inactivation of the antibody upon heat treatment and the subsequent nonspecific adsorption of the antigen on the inactivated antibody. On the contrary, in the case of immobilization via the oligonucleotide, it is seen that there is a distinct difference between the case of using the anti-HBs antibody and the case of using the normal antibody. This suggests that this reaction is not a nonspecific reaction but an antigen-antibody reaction-based one.

Thus, the results shown in FIG. 12 strongly suggest that the method of immobilizing a biomolecule, through the intermediary of an oligonucleotide, in microchannels to be formed in the thermal plastic fusion process including the step of heating the substrate at about 130° C. for about 20 minutes be superior to direct immobilization of a biopolymer in microchannels.

### EXAMPLE 3

This example (Example 3) is concerned with an immunoassay using a plastic chip prepared by thermal fusion following application of an oligonucleotide to a substrate.

(1) Plastic Chip Production

Using a cycloolefin substrate (product of Sumitomo Bakelite Co., Ltd.) activated by aldehyde treatment, a rectangular substrate with a full length of 75 mm and a width of 25 mm in shape was prepared, a passage inlet and a passage outlet, each 1 mm ø in diameter, were formed at a site 5 mm from each end of the substrate by a cutting procedure and four grooves for forming channels with a channel width of 300 μm and a channel depth of 100 μm were formed by a cutting procedure so that the channels might become parallel to one another at 7-mm intervals. A substrate provided with channel grooves was this obtained.

Separately, a solution containing an oligonucleotide having the sequence NH₂-ATA GTG TTC TGG GTT AGC AA (oligonucleotide C shown under SE ID NO:3) at a concentration of 25 mM was spotted for immobilization, using a micropipette, on a cycloolefin substrate activated by aldehyde treatment to form 15 spots with a diameter of about 1 mm so that they might be arranged on each channel groove on the channel groove-carrying substrate upon joining both substrates together. This immobilized oligonucleotide C-carrying substrate and the channel groove-carrying substrate obtained in the above step were joined together by thermal fusion treatment at between 110-135° C. to give a plastic chip having channels, 300 μm in channel width and 100 μm in channel depth, formed therein.

(2) Immunoassaying

Blocking was performed by feeding PBS containing 1% BSA and 1 mM EDTA (hereinafter, “PBS-BSA”) to the channels in the plastic chip obtained in the above step. Then, PBS-BSA containing 50 μg/mL of an anti-HBs antibody bound to an oligonucleotide having the sequence TTG CTA ACC CAG AAC ACT AT (oligonucleotide D shown under SEQ ID NO:4) complementary to the oligonucleotide immobilized in the step (1) mentioned above was fed for 10 minutes, followed by washing by feeding PBS-BSA alone for 3 minutes. Then, PBS-BSA containing 1 μg/mL of a biotinylated anti-HBs antibody was fed for 10 minutes, followed by washing by feeding PBS-BSA alone for 3 minutes. Then, PBS-BSA containing 50 mU/mL of HRP (horseradish-derived peroxidase)-labeled streptavidin (product of Roche) was fed for 10 minutes, followed by washing by feeding PBS-BSA alone for 3 minutes. Thereafter, while feeding SATBlue (product of Dojindo Laboratories), the substrate of HRP, SATBlue color development caused by the enzymatic activity of HRP was detected using a SELFOC type thermal lens microscope (GRIN Spectra, product of Institute of Microchemical Technology Co.). The results obtained are shown in FIG. 13, with the thermal lens signal intensity (voltage) being taken as the ordinate.

(3) Results

According to the graph in FIG. 13, it is seen that a high signal was obtained when 100 ng/mL HBsAg was reacted as compared with the blank not reacted with HBsAg. This indicates that the immobilized oligonucleotide will not be inactivated even upon thermal fusion treatment necessary for preparing plastic chips and that biopolymers can be detected using chips thermally fused after oligonucleotide immobilization.

### INDUSTRIAL APPLICABILITY

The invention makes it possible to confirm the occurrence of biological substances such as biopolymers and quantitate such substances rapidly with very small amounts of samples and, therefore, it reduces the pain given to the human body upon sample collection, hence is useful in clinical diagnosis. The assaying of biological substances according to the invention is useful in chemical and pharmaceutical industries and, further, in food industries, agricultural technologies and a large number of other biotechnology-related industries.

1. An analytical kit comprising:
i) an analytical device comprising a passage allowing a liquid to flow through the same, formed by bonding together a first member having a groove, 1 μm to 5 mm width and 1 μm to 750 μm depth in cross-section, and a second member covering the groove, and a first nucleic acid (N1) having an arbitrary base sequence and immobilized in a capturing zone provided in the passage on the first member and/or second member prior to bonding the first member and second member together;
ii) a reagent A containing (1) a conjugate (N2-L1) composed of a second nucleic acid (N2) having a sequence at least complementary to the base sequence of the first nucleic acid and (2) a first ligand (L1) capable of specifically binding to a biological substance (O) to be assayed;
iii) a reagent B containing a conjugate (L2-M) resulting from binding of a marker (M) to a second ligand (L2) capable of specifically binding to the biological substance (O) to be assayed.

2. An analytical kit comprising:
i) an analytical device comprising a passage allowing a liquid to flow through the same, formed by bonding together a first member having a groove, 1 μm to 5 mm width and 1 μm to 750 μm depth in cross-section, and a second member covering the groove, and a first nucleic acid (N1) having an arbitrary base sequence and immobilized in a capturing zone provided in the passage on the first member and/or second member prior to bonding the first member and second member together;
ii) a reagent A containing a conjugate (N2-L1) composed of (1) a second nucleic acid (N2) having a sequence at least complementary to the base sequence of the first nucleic acid and (2) a first ligand (L1) capable of specifically binding to a biological substance (O) to be assayed;
iii) a reagent B′ containing a second ligand (L2) capable of specifically binding to the biological substance (O) to be assayed; and
iv) a reagent C containing a conjugate (L3-M) composed of a third ligand (L3) capable of specifically binding to the second ligand (L2) and a marker (M).

3. An analytical kit containing no marker and comprising:
i) an analytical device comprising a passage allowing a liquid to flow through the same, formed by bonding together a first member having a groove, 1 μm to 5 mm width and 1 μm to 750 μm depth in cross-section, and a second member covering the groove, and a first nucleic acid (N1) having an arbitrary base sequence and immobilized in a capturing zone provided in the passage on the first member and/or second member prior to bonding the first member and second member together; and
ii) a reagent A containing a conjugate (N2-L1) composed of (1) a second nucleic acid (N2) having a sequence at least complementary to the base sequence of the first nucleic acid (N1) immobilized in the capturing zone of the analytical device and (2) a first ligand (L1) capable of specifically binding to a biological substance (O) to be assayed.

4. An analytical kit comprising:
i) an analytical device comprising a passage allowing a liquid to flow through the same formed by bonding together a first member having a groove, 1 μm to 5 mm width and 1 μm to 750 μm depth in cross-section, and a second member covering the groove, a first nucleic acid (N1) having an arbitrary base sequence and immobilized in a capturing zone provided in the passage on the first member and/or second member prior to bonding the first member and second member together, and a conjugate (N2-L1) composed of a first ligand (L1) capable of specifically binding to a biological substance (O) to be assayed and a second nucleic acid (N2) having a base sequence at least complementary to the immobilized first nucleic acid and immobilized in the capturing zone in the form of a conjugate (N1-N2-L1) by specific binding between the first nucleic acid (N1) and second nucleic acid (N2); and
ii) a reagent B containing a conjugate (L2-M) resulting from binding between a second ligand (L2) capable of specifically binding to the biological substance (O) to be assayed and a marker (M).

5. An analytical kit comprising the reagent B′, reagent C and analytical device specified below in combination:
i) an analytical device comprising a passage allowing a liquid to flow through the same, formed by bonding together a first member having a groove, 1 μm to 5 mm width and 1 μm to 750 μm depth in cross-section, and a second member covering the groove, a first nucleic acid (N1) having an arbitrary base sequence and immobilized in a capturing zone provided in the passage on the first member and/or second member prior to bonding the first member and second member together, and a conjugate (N2-L1) composed of a first ligand (L1) capable of specifically binding to a biological substance (O) to be assayed and a second nucleic acid (N2) having a base sequence at least complementary to the immobilized first nucleic acid (N1) and immobilized in the capturing zone in the form of a conjugate (N1-N2-L1) by specific binding between the first nucleic acid (N1) and second nucleic acid (N2); and
ii) a reagent B′ containing a second ligand (L2) capable of specifically binding to the biological substance (O) to be assayed; and
iii) a reagent C containing a conjugate (L3-M) composed of a third ligand (L3) capable of specifically binding to the second ligand (L2) and a marker (M).

6. An analytical kit comprising:
i) an analytical device comprising a passage allowing a liquid to flow through the same, formed by bonding together a first member having a groove, 1 μm to 5 mm width and 1 μm to 750 μm depth in cross-section, and a second member covering the groove, and a plurality of first nucleic acid species (N1g: g being an integer), each having an arbitrary base sequence and immobilized independently, from species to species, in a capturing zone provided in the passage on the first member and/or second member prior to bonding the first member and second member together;
ii) a reagent A solution containing a plurality of conjugate species (N2h-L1i: h and i each independently being an integer), each composed of (1) one of a plurality of second nucleic acid species (N2h: h being an integer) and each having a sequence at least complementary to the base sequence of one of the plurality of first nucleic acid species and (2) one of a plurality of first ligand species (L1i: i being an integer) which is capable of specifically binding to the corresponding one of biological substance species (Ok: k being an integer) to be assayed; and
iii) a reagent B containing conjugate species (L2j -M1: j and 1 each independently being an integer) resulting from binding between one or more second ligand species (L2j: j being an integer) capable of specifically binding to corresponding one of biological substance species to be assayed and one or more marker species (M1: 1 being an integer).

7. An analytical kit comprising:
i) an analytical device comprising a passage allowing a liquid to flow through the same, formed by bonding together a first member having a groove, 1 μm to 5 mm width and 1 μm to 750 μm depth in cross-section, and a second member covering the groove, and a plurality of first nucleic acid species (N1g: g being an integer) each having an arbitrary base sequence and immobilized independently, from species to species, in a capturing zone provided in the passage on the first member and/or second member prior to bonding the first member and second member together;
ii) a reagent A solution containing a plurality of conjugate species (N2h-L1i: wherein h and i are integers, each composed of (1) one of a plurality of second nucleic acid species (N2h: h being an integer), each having a sequence at least complementary to the base sequence of one of the plurality of first nucleic acid species and (2) one of a plurality of first ligand species (L1i: i being an integer) which is capable of specifically binding to one of biological substance species (Ok: k being an integer) to be assayed;
iii) a reagent B′ containing one or more second ligand species (L2j: j being an integer), each capable of specifically binding to one of the one or more biological substance species to be assayed; and
iv) a reagent C containing conjugate species (L3m-M1: wherein m and 1 are integers composed of one or more third ligand species (L3m: m being an integer) capable of specifically binding to a corresponding one of the one or more second ligand species and one or more marker species (M1: 1 being an integer).

8. An analytical kit comprising:
i) an analytical device comprising a passage allowing a liquid to flow through the same and formed by bonding together a first member having a groove, 1 μm to 5 mm width and 1 μm to 750 μm depth in cross-section, and a second member capable of covering the groove, and a plurality of first nucleic acid species (N1g: g being an integer), each having an arbitrary base sequence and immobilized independently, from species to species, in a capturing zone provided in the passage on the first member and/or second member prior to bonding the first member and second member together;
ii) a reagent A containing a plurality of conjugate species (N2h-L1i: h and i each independently being an integer), each composed of one of a plurality of second nucleic acid species (N2h: h being an integer), each having a sequence at least complementary to the base sequence of the corresponding one of the plurality of first nucleic acid species and one of a plurality of first ligand species (L1i: i being an integer) which is capable of specifically binding to a corresponding one of biological substance species (Ok: k being an integer) to be assayed.

9. An analytical kit comprising the reagent B and analytical device specified below in combination:
i) an analytical device comprising a passage allowing a liquid to flow through the same and formed by bonding together a first member having a groove, 1 μm to 5 mm width and 1 μm to 750 μm depth in cross-section, and a second member covering the groove, and a plurality of first nucleic acid species (N1g: g being an integer), each having an arbitrary base sequence and immobilized independently, from species to species, in a capturing zone provided in the passage on the first member and/or second member prior to bonding the first member and second member together, and conjugate species (N2h-L1i: wherein h and i are each an integer), each composed of one of a plurality of first ligand species (L1i: i being an integer), which is capable of specifically binding to a corresponding one of biological substance species (Ok: k being an integer) to be assayed, and one of a plurality of second nucleic acid species (N2h: h being an integer) and which has a base sequence at least complementary to one of the first nucleic acid species immobilized in the capturing zone in the form of conjugate species (N1g-N2h-L1i: g, wherein h and i are each an integer) by specific binding between the first nucleic acid species and second nucleic acid species; and
ii) a reagent B containing conjugate species (L2j-M1: wherein j and 1 are each an integer) resulting from binding between one or more second ligand species (L2j: j being an integer) respectively capable of specifically binding to the corresponding one biological substance species to be assayed and one or more marker species (M1: 1 being an integer).

10. An analytical kit comprising:
i) an analytical device comprising a passage allowing a liquid to flow through the same, formed by bonding together a first member having a groove, 1 μm to 5 mm width and 1 μm to 750 μm depth in cross-section, and a second member covering the groove, a plurality of first nucleic acid species (N1g: g being an integer), each having an arbitrary base sequence and immobilized independently, from species to species, in a capturing zone provided in the passage on the first member and/or second member prior to bonding the first member and second member together, and conjugate species (N2h-L1i: h and i each independently being an integer), each composed of one of a plurality of first ligand species (L1i: i being an integer), which is capable of specifically binding to a corresponding one of the one or more biological substance species (Ok: k being an integer) to be assayed, and one of a plurality of second nucleic acid species (N2h: h being an integer), which has a base sequence at least complementary to a corresponding one of the immobilized first nucleic acid species (N1g: g being an integer), each conjugate species (N2h-L1i) independently immobilized in the capturing zone in the form of conjugate species (N1g-N2h-L1i: wherein g, h and i are each an integer) by specific binding between the first nucleic acid species and second nucleic acid species; and
ii) a reagent B′ containing one or more second ligand species (L2j: j being an integer) capable of specifically binding to a corresponding one of the biological substance species to be assayed;
iii) a reagent C containing conjugate species (L3m-M1: wherein m and 1 are each an integer) derived from one or more third ligand species (L3m: m being an integer) capable of specifically binding to corresponding one of the second ligand species (L2j: j being an integer) and one or more marker species (M1: 1 being an integer).

11. An analytical kit according to any of claims 1 to 10, wherein the biological substance(s), first ligand(s) (L1 or L1i: i being an integer), second ligand(s) (L2 or L2j: j being an integer) and/or third ligand(s) (L3 or L3m: m being an integer) is/are selected from among immunological substances, receptors, receptor-binding substances, sugars, glycoproteins, glycolipids, lectins and nucleic acids.

12. An analytical kit according to claim 1, 2, 3, 4, 5, 6, 7, 8, 9 or 10, wherein the first ligand or ligands (L1 or L1i: i being an integer) and/or second ligand or ligands (L2 or L2j: j being an integer) are different in reactivity.

13. An analytical kit according to claim 1, 2, 3, 4, 5, 6, 7, 8, 9 or 10, wherein the first ligand or ligands (L1 or L1i: i being an integer) and/or second ligand or ligands (L2 or L2j: j being an integer) are identical in reactivity.

14. An analytical kit according to any of claims 1 to 10, wherein the marker or markers (M or M1: 1 being an integer) each is selected from among enzymes, colloidal metals, latexes, nucleic acids, luminescent substances, fluorescent substances, intercalators, biotin, avidin and streptavidin.

15. (canceled)

16. (canceled)

17. (canceled)

18. An analytical device comprising a passage allowing a liquid to flow through the same, formed by bonding together a first member having a groove, 1 μm to 5 mm width and 1 μm to 750 μm depth in cross-section, and a second member covering the groove to form the passage, a first nucleic acid (N1) having an arbitrary base sequence immobilized in a capturing zone provided in the passage prior to bonding the first member and second member together, and a conjugate (N2-L1) composed of a first ligand (L1) capable of specifically binding to a biological substance (O) to be assayed and a second nucleic acid (N2) having a base sequence at least complementary to the immobilized first nucleic acid (N1) and immobilized in the capturing zone by specific binding between the first nucleic acid (N1) and second nucleic acid (N2).

19. An analytical device comprising a passage allowing a liquid to flow through the same formed by bonding together a first member having a groove, 1 μm to 5 mm width and 1 μm to 750 μm depth in cross-section, and a second member covering the groove to form the passage, a plurality of first nucleic acid species (N1g: g being an integer), each having an arbitrary base sequence and immobilized independently, from species to species, in a capturing zone provided in the passage on the first member and/or second member prior to bonding the first member and second member together, conjugate species (N2h-L1i: h and i each being an integer), each conjugate species being composed of one of a plurality of a first ligand species (L1i: i being an integer), which is capable of specifically binding to a corresponding one of biological substance species (Ok: k being an integer) to be assayed, and one of a plurality of second nucleic acid species (N2h: h being an integer), each of which has a base sequence at least complementary to a corresponding one of the immobilized first nucleic acid species and which is immobilized independently, from species to species, in the capturing zone by specific binding between the first nucleic acid species and second nucleic acid species.

20. (canceled)

21. (canceled)

22. (canceled)

23. (canceled)

24. An analytical method comprising:
preparing an analytical device, comprising a passage allowing a liquid to flow through the same, by bonding together a first member having a groove, 1 μm to 5 mm width and 1 μm to 750 μm depth in cross-section, and a second member covering the groove;
immobilizing a first nucleic acid (N1), having an arbitrary base sequence, in a capturing zone provided in the passage on the first member and/or second member prior to bonding the first member and second member together;
preparing a reagent A containing a conjugate (N2-L1) resulting from binding of a first ligand (L1), capable of specifically binding to a biological substance to be assayed, to a second nucleic acid (N2) having a sequence at least complementary to the base sequence of the first nucleic acid (N1);
mixing a liquid sample suspected of containing the biological substance to be assayed and the reagent A, either after conjugate formation or while allowing conjugate formation to form a mixture;
introducing the mixture into the passage in the analytical device to immobilize the conjugate within the passage; and
assaying the immobilized conjugate.

25. An analytical method comprising:
preparing an analytical device, comprising a passage allowing a liquid to flow through the same, by bonding together a first member having a groove, 1 μm to 5 mm width and 1 μm to 750 μm depth in cross-section, and a second member covering the groove;
immobilizing a first nucleic acid (N1), having an arbitrary base sequence, in a capturing zone provided in the passage on the first member and/or second member prior to bonding the first member and second member together;
preparing a reagent A containing a conjugate (N2-L1) resulting from binding of a first ligand (L1), capable of specifically binding to a biological substance to be assayed, to a second nucleic acid (N2) having a sequence at least complementary to the base sequence of the first nucleic acid (N1);
separately introducing a liquid sample suspected to contain the biological substance to be assayed and the reagent A, without preliminary mixing of the liquid sample and reagent A, into the passage in the analytical device to immobilize the conjugate within the passage; and
assaying the immobilized conjugate.

26. An analytical method comprising:
preparing an analytical device, comprising a passage allowing a liquid to flow through the same, by bonding together a first member having a groove, 1 μm to 5 mm width and 1 μm to 750 μm depth in cross-section, and a second member covering the groove;
immobilizing a plurality of first nucleic acid species (N1g: g being an integer), each having an arbitrary base sequence, independently from species to species, in a capturing zone provided in the passage on the first member and/or second member prior to bonding the first member and second member together;
preparing a reagent A containing a plurality of conjugate species (N2h-L1i: h and i each being an integer), each resulting from binding of (1) one of a plurality of first ligand species (L1i: i being an integer), capable of specifically binding to a corresponding one of biological substance species (Ok: k being an integer) to be assayed, to (2) one of a plurality of second nucleic acid species (N2h: h being an integer), each having a sequence at least complementary to the base sequence of a corresponding one of the plurality of first nucleic acid species;
mixing a liquid sample, suspected of containing one or more of the biological substance species to be assayed, and the reagent A to form a mixture;
introducing the mixture, either after conjugate formation or while allowing conjugate formation, into the passage in the analytical device to immobilize one or more of the conjugate species within the passage; and
assaying the immobilized conjugate(s).

27. An analytical method comprising:
preparing an analytical device, comprising a passage allowing a liquid to flow through the same, by bonding together a first member having a groove, 1 μm to 5 mm width and 1 μm to 750 μm depth in cross-section, and a second member covering the groove;
immobilizing a plurality of first nucleic acid species (N1g: g being an integer), each having an arbitrary base sequence, independently from species to species, in a capturing zone provided in the passage on the first member and/or second member prior to bonding the first member and second member together;
preparing a reagent A containing a plurality of conjugate species (N2h-L1i: h and i each being an integer) each resulting from binding of (1) one of a plurality of first ligand species (L1i: i being an integer), capable of specifically binding to one of biological substance species (Ok: k being an integer) to be assayed, to (2) one of a plurality of second nucleic acid species (N2h: h being an integer), each having a sequence at least complementary to the base sequence of a corresponding one of the plurality of first nucleic acid species;
separately introducing (1) a liquid sample suspected of containing one or more of the biological substances to be assayed and (2) the reagent A into the passage in the analytical device to immobilize the resulting one or more conjugate species within the passage; and
assaying the immobilized conjugate(s).

28. An analytical method using an analytical kit according to claim 1, the method comprising:
mixing two or more of the following materials a, b and c, either after conjugate formation or while allowing conjugate formation, to form a mixture;
a. a liquid sample suspected of containing a biological substance (O) to be assayed,
b. the reagent A containing the conjugate (N2-L1),
c. the reagent B containing the conjugate (L2-M);
introducing the mixture into the passage in the analytical device contained in the analytical kit, followed by introduction of the remaining material of a, b and c, if any, into the passage;
allowing the formation of an immobilized conjugate (N1-N2-L1-O-L2-M) by specific binding between the first nucleic acid (N1) immobilized in the capturing zone in the analytical device and the second nucleic acid (N2), specific binding between the first ligand (L1) and biological substance (O) and specific binding between the second ligand (L2) and biological substance (O); and
assaying the biological substance (O) by detecting the marker (M) contained in the immobilized conjugate (N1-N2-L1-O-L2-M).

29. An analytical method using an analytical kit according to claim 1, the method comprising:
separately introducing the following materials a, b and c given below individually, without mixing together, into the passage in the analytical device contained in the analytical kit:
a. a liquid sample suspected of containing a biological substance (O) to be assayed,
b. the reagent A containing a conjugate (N2-L1),
c. the reagent B containing the conjugate (L2-M);
allowing the formation of an immobilized conjugate (N1-N2-L1-O-L2-M) by specific binding between the first nucleic acid (N1) immobilized in the capturing zone and the second nucleic acid (N2), specific binding between the first ligand (L1) and biological substance (O) and specific binding between the second ligand (L2) and biological substance (O); and
assaying the biological substance (O) by detecting the marker (M) contained in the immobilized conjugate (N1-N2-L1-O-L2-M).

30. An analytical method using the analytical kit according to claim 2, the method comprising:
mixing two or more of the following materials a, b, c and d, either after conjugate formation or while allowing conjugate formation, to form a mixture:
a. a liquid sample suspected of containing a biological substance (O) to be assayed,
b. the reagent A containing a conjugate (N2-L1),
c. the reagent B′ containing a second ligand (L2), and
d. the reagent C containing a conjugate (L3-M);
introducing the mixture into the passage in the analytical device contained in the analytical kit, followed by introduction of the remaining material or materials a, b, c and d, if any, into the passage;
allowing formation of an immobilized conjugate (N1-N2-L1-O-L2-L3-M) by specific binding between the first nucleic acid (N1) immobilized in the capturing zone and the second nucleic acid (N2), specific binding between the first ligand (L1) and the biological substance (O), specific binding between the second ligand (L2) and the biological substance (O) and specific binding between the second ligand (L2) and third ligand (L3); and
assaying the biological substance (O) by detecting the marker (M) contained in the immobilized conjugate (N1-N2-L1-O-L2-L3-M).

31. An analytical method using the analytical kit according to claim 2, the method comprising:
separately introducing the following materials a, b, c and d individually, without any mixing, into the passage in the analytical device contained in the analytical kit:
a. a liquid sample suspected of containing a biological substance (O) to be assayed,
b. the reagent A containing the conjugate (N2-L1),
c. the reagent B′ containing the second ligand (L2), and
d. the reagent C containing the conjugate (L3-M);
allowing the formation of an immobilized conjugate (N1-N2-L1-O-L2-L3-M) by specific binding between the first nucleic acid (N1) immobilized in the capturing zone and the second nucleic acid (N2), specific binding between the first ligand (L1) and biological substance (O), specific binding between the second ligand (L2) and biological substance (O) and specific binding between the second ligand (L2) and third ligand (L3); and
assaying the biological substance (O) by detecting the marker (M) contained in the immobilized conjugate (N1-N2-L1-O-L2-L3-M).

32. An analytical method using the analytical kit according to claim 2, the method comprising:
preparing a marker-carrying biological substance (O-M) in advance from a liquid sample suspected of containing a biological substance (O) to be assayed by introduction of a marker (M) into that substance;
introducing the reagent A containing the conjugate (N2-L1), either after conjugate formation or while allowing conjugate formation, into the passage in the analytical device contained in the analytical kit;
allowing the formation of an immobilized conjugate (N1-N2-L1-O-M) by specific binding between the first nucleic acid (N1) immobilized in the capturing zone and the second nucleic acid (N2); and
assaying the biological substance (O) by detecting the marker (M) contained in the immobilized conjugate (N1-N2-L1-O-M).

33. An analytical method using the analytical kit according to claim 2, the method comprising:
preparing a marker-carrying biological substance (O-M) in advance from a liquid sample suspected of containing a biological substance (O) to be assayed by introduction of a marker (M) into that substance;
separately introducing (1) the reagent A containing the conjugate (N2-L1) assayed and (2) the marker-carrying biological substance (O-M) individually, without mixing together, into the passage in the analytical device contained in the analytical kit;
allowing the formation of an immobilized conjugate (N1-N2-L1-O-M) by specific binding between the first nucleic acid (N1) immobilized in the capturing zone and the second nucleic acid (N2); and
assaying the biological substance (O) by detecting the marker (M) contained in the immobilized conjugate (N1-N2-L1-O-M).

34. An analytical method using the analytical kit according to claim 4, the method comprising:
mixing the following materials a and b to form a mixture:
a. a liquid sample suspected of containing a biological substance (O) to be assayed,
b. the reagent B containing the conjugate (L2-M);
introducing the mixture, either after conjugate formation or while allowing conjugate formation, into the passage in the analytical device;
allowing the formation of an immobilized conjugate (N1-N2-L1-O-L2-M) by specific binding between the first ligand (L1) in the conjugate (N1-N2-L1) immobilized in the capturing zone and the biological substance (O) and by specific binding between the second ligand (L2) in the conjugate (L2-M) and the biological substance (O); and
assaying the biological substance (O) by detecting the marker (M) contained in the immobilized conjugate (N1-N2-L1-O-L2-M).

35. An analytical method using an analytical kit according to claim 4, the method comprising:
separately introducing the following materials a and b individually, without mixing together, into the passage in the analytical device contained in the analytical kit:
a. a liquid sample suspected of containing a biological substance (O) to be assayed,
b. the reagent B containing the conjugate (L2-M);
allowing formation of an immobilized conjugate (N1-N2-L1-O-L2-M) by specific binding between the first ligand (L1) in the conjugate (N1-N2-L1) immobilized in the capturing zone in the analytical device and the biological substance (O) and by specific binding between the second ligand (L2) in the conjugate (L2-M) and the biological substance (O); and
assaying the biological substance (O) by detecting the marker (M) contained in the immobilized conjugate (N1-N2-L1-O-L2-M).

36. An analytical method using an analytical kit according to claim 5, the method comprising:
mixing two or more of the following materials a, b and c to form a mixture;
a. a liquid sample suspected of containing the biological substance (O) to be assayed,
b. the reagent B′, and,
c. the reagent C containing the conjugate (L3-M);
introducing the mixture, either after further conjugate formation or while allowing further conjugate formation, into the passage in the analytical device, followed by introduction of the remaining material a, b or c, if any, into the passage;
allowing further conjugate formation to produce an immobilized conjugate (N1-N2-L1-O-L2-L3-M) by specific binding between the first ligand (L1) in the conjugate (N1-N2-L1) immobilized in the capturing zone and the biological substance (O), specific binding between the second ligand (L2) and biological substance (O) and specific binding between the second ligand and third ligand; and
assaying the biological substance (O) by detecting the marker (M) contained in the immobilized conjugate (N1-N2-L1-O-L2-L3-M).

37. An analytical method using an analytical kit according to claim 5, the method comprising:
introducing the following materials a, b and c individually, without mixing together, into the passage in the analytical device contained in the analytical kit:
a. a liquid sample suspected of containing a biological substance (O) to be assayed,
b. the reagent B′ containing the second ligand (L2)
c. the reagent C containing the conjugate (L3-M);
allowing the formation of an immobilized conjugate (N1-N2-L1-O-L2-L3-M) by specific binding between the first ligand (L1) in the conjugate (N1-N2-L1) immobilized in the capturing zone and the biological substance (O), specific binding between the second ligand (L2) and biological substance (O) and specific binding between the second ligand and third ligand; and
assaying the biological substance (O) by detecting the marker (M) contained in the immobilized conjugate (N1-N2-L1-O-L2-L3-M).

38. An analytical method using an analytical kit according to claim 6, the method comprising:
mixing two or more of the following materials a, b and c to form a mixture:
a. a liquid sample suspected of containing one or more biological substance species (Ok: k being an integer) to be assayed,
b. the reagent A solution containing conjugate species N2h-L1i, and;
c. the reagent B containing conjugate species L2j-M1;
introducing the mixture, either after conjugate formation or while allowing conjugate formation, into the passage in the analytical device contained in the analytical kit, followed by further introduction of the remaining material a, b, and c, if any, into the passage;
allowing the formation of conjugate species (N1g-N2h-L1i-Ok-L2j-M1: wherein g, h, i, j, k and 1 are each an integer), each immobilized independently, from species to species, by specific binding between the plurality of first nucleic acid species and the plurality of second nucleic acid species, specific binding between the plurality of first ligand species and the one or more biological substance species and specific binding between the one or more second ligand species and the one or more biological substance species; and
assaying the one or more biological substance species by detecting the one or more marker species contained in the plurality of immobilized conjugate species.

39. An analytical method using an analytical kit according to claim 6, the method comprising:
introducing the following materials a, b and c individually, without mixing together, into the passage in the analytical device contained in the analytical kit:
a. a liquid sample suspected of containing one or more biological substance species (Ok: k being an integer) to be assayed,
b. the reagent A solution containing the conjugate species N2h-L1i,
c. the reagent B containing the conjugate species L2j -M1;
allowing the formation of conjugate species (N1g-N2h-L1i-Ok-L2j-M1: wherein g, h, i, j, k and 1 are each integer) immobilized each independently, from species to species, by specific binding between the plurality of first nucleic acid species immobilized independently, from species to species, in the capturing zone and the plurality of second nucleic acid species (N2h), specific binding between the plurality of first ligand species (L1i) and the one or more biological substance species and specific binding between the one or more second ligand species and the one or more biological substance species;
assaying the one or more biological substance species by detecting the one or more marker species (M1) contained in the plurality of immobilized conjugate species N1g-N2h-L1i-Ok-L2j-M1.

40. An analytical method using the analytical kit according to claim 7, the method comprising:
mixing two or more of the following materials a, b, c and d to form a mixture:
a. a liquid sample suspected of containing one or more biological substance species (Ok: k being an integer) to be assayed,
b. the reagent A solution containing conjugate species N2h-L1i,
c. the reagent B′ containing one or more second ligand species L2j, and
d. the reagent C containing conjugate species L3m-M1;
introducing the mixture into the passage in the analytical device, followed by introduction of the remaining materials a, b, c and d, if any, into the passage;
allowing the formation of conjugate species (N1g-N2h-L1i-Ok-L2j-L3m-M1: wherein g, h, i, j, k, 1 and m are each an integer), each immobilized independently, from species to species, by specific binding between the plurality of first nucleic acid species and the plurality of second nucleic acid species, specific binding between the plurality of first ligand species and the one or more biological substance species, specific binding between the one or more second ligand species and the one or more biological substance species and specific binding between the one or more second ligand species and the one or more third ligand species;
assaying the one or more biological substance species by detecting the one or more marker species contained in the plurality of immobilized conjugate species (N1g-N2h-L1i-Ok-L2j-L3m-M1: wherein g, h, i, j, k, 1 and m are each an integer).

41. An analytical method using the analytical kit according to claim 7, the method comprising:
introducing the following materials a, b, c and d individually, without mixing together, into the passage in the analytical device contained in the analytical kit:
a. a liquid sample suspected of containing one or more of the biological substance species to be assayed,
b. the reagent A solution containing conjugate species N2h-L1i,
c. the reagent B′ containing one or more of the second ligand species L2j, and
d. the reagent C containing conjugate species L3m-M1; and
allowing the formation of conjugate species N1g-N2h-L1i-Ok-L2j-L3m-M1 (wherein g, h, i, j, k, 1 and m are each an integer), each immobilized independently, from species to species, by specific binding between the plurality of first nucleic acid species and the plurality of second nucleic acid species, specific binding between the plurality of first ligand species and the one or more biological substance species, specific binding between the one or more second ligand species and the one or more biological substance species and specific binding between the one or more second ligand species and the one or more third ligand species;
assaying the one or more biological substance species by detecting the one or more marker species contained in the plurality of immobilized conjugate species N1g-N2h-L1i-Ok-L2j-L3m-M1).

42. An analytical method using the analytical kit according to claim 8, the method comprising:
preparing at least one marker-carrying biological substance species Ok-M1: (wherein k and 1 are each an integer) from a liquid sample suspected of containing one or more of the biological substance species by introduction of one or more marker species M1 (1 being an integer) into the liquid sample;
introducing the reagent A containing conjugate species N2h-L1i into the passage in the analytical device contained in the analytical kit;
allowing formation of conjugate species N1g-N2h-L1i-Ok-M1 (wherein g, h, i, k and 1 are each being an integer), immobilized each independently, from species to species, by specific binding between the plurality of first nucleic acid species and the plurality of second nucleic acid species and specific binding between the plurality of first ligand species and the at least one biological substance species;
assaying the at least one biological substance species by detecting the one or more marker species contained in the plurality of immobilized conjugate species N1g-N2h-L1i-Ok-M1.

43. An analytical method using the kit according to claim 8, the method comprising:
preparing one or more marker-carrying biological substance species from a liquid sample suspected of containing one or more biological substance species by introduction of one or more marker species M1 (1 being an integer) into the liquid sample;
introducing the reagent A containing conjugate species N2h-L1i into the passage in the analytical device contained in the analytical kit;
allowing the formation of conjugate species N1g-N2h-L1i-Ok-M1 (wherein g, h, i, k and 1 are each an integer), each immobilized independently, from species to species, by specific binding between the plurality of first nucleic acid species immobilized in the capturing zone and the plurality of second nucleic acid species and specific binding between the plurality of first ligand species and the one or more biological substance species; and
assaying the one or more biological substance species by detecting the one or more marker species contained in the plurality of immobilized conjugate species N1g-N2h-L1i-Ok-M1.

44. An analytical method using the analytical kit according to claim 9, the method comprising:
mixing the following materials a and b to form a mixture:
a. a liquid sample suspected of containing the one or more biological substance species,
b. the reagent B;
introducing the mixture into the passage in the analytical device contained in the analytical kit;
allowing the formation of conjugate species N1g-N2h-L1i-Ok-L2j-M1 (wherein g, h, i, j, k and 1 are each an integer), immobilized each independently, from species to species, by specific binding between the plurality of first ligand species in the conjugate species N1g-N2h-L1i and the one or more biological substance species and specific binding between the one or more second ligand species in the conjugate species L2j -M1; and
assaying the one or more biological substance species by detecting the one or more marker species contained in the plurality of immobilized conjugate species N1g-N2h-L1i-Ok-L2j-M1.

45. An analytical method using the analytical kit according to claim 9, the method comprising:
introducing the following materials a and b individually, without mixing together, into the passage in the analytical device contained in the analytical kit:
a. a liquid sample suspected of containing the one or more biological substance species,
b. a reagent B containing conjugate species L2j-M1;
allowing the formation of conjugate species N1g-N2h-L1i-Ok-L2j-M1 (wherein g, h, i, j, k and 1 are each an integer), each immobilized independently, from species to species, by specific binding between the plurality of first ligand species in the conjugate species N1g-N2h-L1i and the one or more biological substance species and specific binding between the one or more second ligand species in the conjugate species L2j -M1 and the one or more biological substance species; and
assaying the one or more biological substance species by detecting the one or more marker species contained in the plurality of immobilized conjugate species N1g-N2h-L1i-Ok-L2j-M1.

46. An analytical method using the analytical kit according to claim 10, the method comprising:
mixing two or more of the following materials a, b and c, either after conjugate formation or while allowing conjugate formation, to form a mixture;
a. a liquid sample suspected of containing the one or more biological substance species to be assayed,
b. the reagent B′ containing one or more second ligand species L2j,
c. the reagent C containing the conjugate species L3m-M1;
introducing the mixture into the passage in the analytical device followed by introduction of the remaining material a, b and c, if any, into the passage;
allowing the formation of immobilized conjugate species N1g-N2h-L1i-Ok-L2j-L3m-M1 (wherein g, h, i, j, k, 1 and m are each an integer) by specific binding between the first ligand species L1i in the conjugate species N1g-N2h-M1i immobilized in the capturing zone in the analytical device and the biological substance species Ok, specific binding between the second ligand species L2j and the biological substance species Ok and specific binding between the second ligand species L2j and the third ligand species L3m;
assaying the one or more biological substance species Ok by detecting the one or more marker species M1 contained in the immobilized conjugate species N1g-N2h-L1i-Ok-L2j-L3m-M1.

47. An analytical method using the analytical kit according to claim 10, the method comprising:
introducing the following materials a, b and c individually, without mixing together, into the passage in the analytical device:
a. a liquid sample suspected of containing one or more of the biological substance species Ok,
b. the reagent B′ containing the one or more second ligand species L2j,
c. the reagent C containing the conjugate species L3m-M1;
allowing the formation of immobilized conjugate species N1g-N2h-L1i-Ok-L2j-L3m-M1 (wherein g, h, i, j, k, 1 are each an integer) by specific binding between the first ligand species L1i in the conjugate species N1g-N2h-M1i and the biological substance species Ok, specific binding between the second ligand species L2j and the biological substance species Ok and specific binding between the second ligand species L2j and the third ligand species L3m; and
assaying the one or more biological substance species Ok by detecting the one or more marker species M1 contained in the immobilized conjugate species N1g-N2h-L1i-Ok-L2j-L3m-M1.

48. An analytical method using the analytical kit according to claim 18, the method comprising the following elements:
preparing in advance a marker-carrying biological substance O-M from a liquid sample suspected of containing a biological substance (O) by introduction of a marker (M) thereinto;
introducing the marker-carrying biological substance O-M into the passage in the analytical device;
allowing the formation of an immobilized conjugate N1-N2-L1-O-M by specific binding between the first ligand L1 in the conjugate L1-N2 immobilized in the capturing zone and the biological substance (O) in the marker-carrying biological substance O-M; and
assaying the biological substance (O) by detecting the marker (M) contained in the immobilized conjugate N1-N2-L1-O-M.

49. An analytical method using the analytical kit according to claim 19, the method comprising:
preparing in advance one or more marker-carrying biological substance species Ok-M1 (wherein k and 1 are each an integer) from a liquid sample suspected of containing one or more of the biological substance species Ok by introduction of one or more markers M1 (1 being an integer) thereinto;
introducing the marker-carrying biological substance species Ok-M1 into the passage in the analytical device;
allowing the formation of immobilized conjugate species N1g-N2h-L1i-Ok-M1 (wherein g, h, i, k and 1 are each an integer) by specific binding between the plurality of first ligand species L1i immobilized in the capturing zone and the one or more marker-carrying biological substance species Ok-M1; and
assaying the one or more biological substance species Ok by detecting the one or more marker species M1 contained in the immobilized conjugate species N1g-N2h-L1i-Ok-M1.

50. (canceled)

51. A method of preparing an analytical device comprising:
preparing a first member having a groove, 1 μm to 5 mm width and 1 μm to 750 μm depth in cross-section, and a second member capable of covering the groove, wherein the groove forms a portion of a passage upon joining the first member and second member together and one of the first member and second member or both have a passage inlet and a passage outlet,
immobilizing a nucleic acid (N), having an arbitrary base sequence, at a site on a portion the first member and/or second member forming the passage, to form a zone for capturing a biological substance to be assayed,
then joining the first member and second member together by thermal fusion or with an adhesive to give an assembly with the passage formed therein,
introducing into the passage a reagent A containing a conjugate (N2-L1) composed of a second nucleic acid (N2) having a base sequence at least complementary to the base sequence of the first nucleic acid (N1) which is immobilized in the capturing zone and a first ligand (L1) capable of specifically binding to a biological substance to be assayed, and
allowing the conjugate (N2-L1) to specifically bind, for immobilization thereof, to the first nucleic acid (N1) in the capturing zone.

52. A method of preparing an analytical device comprising:
preparing a first member having a groove, 1 μm to 5 mm width and 1 μm to 750 μm depth, and a second member capable of covering the groove, wherein the groove forms a portion of a passage upon joining the first member and second member together and one of the first member and second member or both have a passage inlet and a passage outlet,
immobilizing a plurality of first nucleic acid species (N1g: g being an integer) each having an arbitrary base sequence at independent sites forming a zone within the passage for capturing one or more biological substance species to be assayed,
then joining the first member and second member together by thermal fusion or with an adhesive to give an assembly with the passage formed therein, introducing into the passage a reagent A containing conjugate species (N2h-L1i: wherein h and i are each an integer), each composed of one of a plurality of second nucleic acid species (N2h: h being an integer), each second nucleic acid species having a base sequence at least complementary to the base sequence of a corresponding species of the plurality of first nucleic acid species (N1g: g being an integer) immobilized in the capturing zone, and one of a plurality of first ligand species (L1i: i being an integer), each first ligand species being capable of specifically binding to a corresponding species of the one or more biological substance species to be assayed, and
allowing the plurality of conjugate species N2h-L1i to specifically bind, for immobilization thereof, to the plurality of first nucleic acid species previously immobilized in the capturing zone.

53. (canceled)

54. A method of preparing analytical devices as set forth in claim 51 or 52, wherein the biological substance or substances and/or first ligand (L1) or ligands are selected from among immunological substances, receptors and nucleic acids.

55. (canceled)

56. (canceled)

57. (canceled)
